(19) United States
(12) Patent Application Publication
(10) Pub. No.: US 2007/0249634 A1
(43) Pub. Date: Oct. 25, 2007

(54) Triazolopyrimidine Compounds and Use Thereof for Controlling Harmful Fungi

(76) Inventors: Carsten Blettner, Mannheim (DE); Markus Gewehr, Kastellaun (DE); Wassilios Grammenos, Ludwigshafen (DE); Thomas Grote, Wachenheim (DE); Udo Hunger, Mainz (DE); Bern Muller, Frankenthal (DE); Matthias Niedenbruck, Limburgerhof (DE); Joachim Rheinheimer, Ludwigshafen (DE); Petere Schafer, Ottersheim (DE); Frank Schieweck, Hessheim (DE); Anja Schwogler, Mannheim (DE); Oliver Wagner, Neustadt (DE); Liliana Parra Rapado, Offenburg (DE); Michael Rack, Heidelberg (DE); Barbara Nave, Deidesheim (DE); Maria Schere, Godramstein (DE); Siegfried Strathmann, Limburgerhof (DE); Ulrich Schofl, Bruhl (DE); Reinhard Stierl, Freinsheim (DE)

Correspondence Address: BIRCH STEWART KOLASCH & BIRCH, PO BOX 747, FALLS CHURCH, VA, 22040-0747, US

(21) Appl. No.: 11/597,409

(22) PCT Filed: Jun. 8, 2005
(86) PCT No.: PCT/EP05/06170

§ 371 Date: Nov. 22, 2006

(30) Foreign Application Priority Data
Jun. 9, 2004 (DE) 102004028084.3

(51) Int. Cl. A01N 43/90; A01P 3/00

(52) U.S. Cl. 514/259.1

(57) ABSTRACT

The invention relates to the use of triazolopyrimidines of the formula I 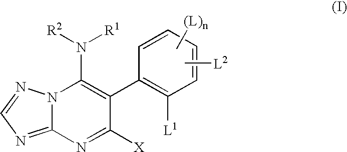 In which:
R¹, R² are hydrogen, alkyl, haloalkyl, cycloalkyl, halocycloalkyl, alkenyl, alkadienyl, haloalkenyl, cycloalkenyl, halocycloalkenyl, alkynyl, haloalkynyl, C₃-C₆-cycloalkynyl, phenyl, naphthyl, or a five- to ten-membered saturated, partially unsaturated or aromatic heterocycle which contains one, two, three or four heteroatoms from the group consisting of O, N and S, where R¹, R² may be substituted as defined in the description or R¹ and R² together with the nitrogen atom to which they are attached may form five- to eight-membered heterocyclyl or heteroaryl which is attached via nitrogen and may contain one, two or three further heteroatoms from the group consisting of O, N and S as ring members and/or may be substituted as defined in the description;
L independently of one another are halogen, alkyl, haloalkyl, alkoxy, haloalkoxy, alkenyloxy, cyano, C(═O)A¹, S(═O)ₘA², NR^{c}R^{d} or NR^{c}—(C═O)—R^{d}, where A¹, A², R^{c}, R^{d} and m are as defined in the description;
L¹ is halogen, alkyl or haloalkyl;
L² is nitro, a group —C(S)NR³R⁴, a group —C(═N—OR⁵)(NR⁶R⁷) or a group —C(═N—NR⁸R⁹)(NR¹⁰OR¹¹); X is halogen, cyano, alkyl, alkoxy, haloalkyl or haloalkoxy;
R³, R⁴, R⁵, R⁶, R⁷, R⁸, R⁹, R¹⁰ and R¹¹ are independently of one another selected from the group consisting of hydrogen, alkyl, cycloalkyl, alkenyl and alkynyl, where the 4 last-mentioned radicals may be substituted as defined in the description; or R³ and R⁴, or R⁶ and R⁷, or R⁸ and R⁹ or R¹⁰ and R¹¹ together with the nitrogen atom to which they are attached form a four, five, or six-membered saturated or partially unsaturated ring which may be substituted as defined in the description; n is 0, 1, 2 or 3; and the agriculturally acceptable salts thereof, novel triazolopyrimidines, crop protection compositions comprising at least one compound of the formula I and at least one solid or liquid carrier, and a method for controlling phytopathogenic harmful fungi.

The present invention relates to novel triazolopyrimidine compounds, to their use for controlling harmful fungi and to crop protection compositions comprising, as active component, at least one such compound.

Fungicidally active 1,2,4-triazolopyrimidines carrying an optionally substituted phenyl ring in the 6-position and an amino group in the 7-position are known, for example from EP 0 550 113, WO 98/46608, U.S. Pat. No. 6,255,309, GB 2,355,261, WO 02/088125 and WO 99/41255. Mentioned as possible substituent on the phenyl ring is, inter alia, the nitro group. Examples for this are not given.

Some of the triazolopyrimidines known from the prior art are, with a view to their fungicidal activity, unsatisfactory, or they have unwanted properties, such as poor compatibility with crop plants.

WO 04/041824 describes 1,2,4-triazolopyrimidines having an optionally substituted amino radical in the 7-position which may carry a 2-chloro-4-nitrophenyl radical or a 2-fluoro-4-nitrophenyl radical in the 6-position. A fungicidal action of these compounds is not disclosed.

Accordingly, it is an object of the present invention to provide 1,2,4-triazolopyrimidines having improved fungicidal activity and/or crop plant compatibility.

Surprisingly, this object is achieved by the triazolopyrimidines of the formula I described below 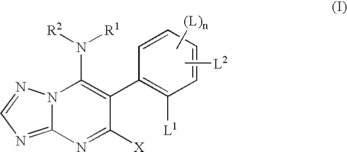
in which:
R¹, R² independently of one another are hydrogen, C₁-C₈-alkyl, C₁-C₈-haloalkyl, C₃-C₁₀-cycloalkyl, C₃-C₈-halocycloalkyl, C₂-C₈-alkenyl, C₄-C₁₀-alkadienyl, C₂-C₈-haloalkenyl, C₃-C₈-cycloalkenyl, C₃-C₈-halocycloalkenyl, C₂-C₈-alkynyl, C₂-C₈-haloalkynyl, phenyl, naphthyl, or a five- to ten-membered saturated, partially unsaturated or aromatic heterocycle which contains one, two, three or four heteroatoms from the group consisting of O, N or S, or
R¹ and R² together with the nitrogen atom to which they are attached form a five- six- seven- or eight-membered heterocyclyl or heteroaryl which is attached via nitrogen and may contain one, two or three further heteroatoms from the group consisting of O, N and S as ring members and/or may carry one or more, e.g. 1, 2, 3 or 4, substituents from the group consisting of halogen, C₁-C₆-alkyl, C₁-C₆-haloalkyl, C₂-C₆-alkenyl, C₂-C₆-haloalkenyl, C₁-C₆-alkoxy, C₁-C₆-haloalkoxy, C₃-C₆-alkenyloxy, C₃-C₆-haloalkenyloxy, (exo)-C₁-C₆-alkylene and oxy-C₁-C₃-alkyleneoxy;
where R¹ and R² may carry one, two, three or four identical or different groups R^{a}:
R^{a} is halogen, cyano, nitro, hydroxyl, C₁-C₆-alkyl, C₁-C₆-haloalkyl, C₁-C₆-alkylcarbonyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₂-C₈-alkenyl, C₂-C₈-haloalkenyl, C₃-C₆-cycloalkenyl, C₂-C₆-alkenyloxy, C₃-C₆-haloalkenyloxy, C₂-C₆-alkynyl, C₂-C₆-haloalkynyl, C₃-C₆-alkynyloxy, C₃-C₆-haloalkynyloxy, C₃-C₆-cycloalkoxy, C₃-C₈-cycloalkenyloxy, oxy-C₁-C₃-alkyleneoxy, phenyl, naphthyl, a five- to ten-membered saturated, partially unsaturated or aromatic heterocycle which contains one, two, three or four heteroatoms from the group consisting of O, N and S,
   where these aliphatic, alicyclic or aromatic groups for their part may be partially or fully halogenated or may carry one, two or three groups R^{b}:
   R^{b} is halogen, cyano, nitro, hydroxyl, mercapto, amino, carboxyl, aminocarbonyl, aminothiocarbonyl, alkyl, haloalkyl, alkenyl, alkenyloxy, alkynyloxy, alkoxy, haloalkoxy, alkylthio, alkylamino, dialkylamino, formyl, alkylcarbonyl, alkylsulfonyl, alkylsulfoxyl, alkoxycarbonyl, alkylcarbonyloxy, alkylaminocarbonyl, dialkylaminocarbonyl, alkylaminothiocarbonyl, dialkylaminothiocarbonyl, where the alkyl groups in these radicals contain 1 to 6 carbon atoms and the alkenyl or alkynyl groups mentioned in these radicals contain 2 to 8 carbon atoms;
   and/or one to three of the following radicals:
   cycloalkyl, cycloalkoxy, heterocyclyl, heterocyclyloxy, where the cyclic systems contain 3 to 10 ring members; aryl, aryloxy, arylthio, aryl-C₁-C₆-alkoxy, aryl-C₁-C₆-alkyl, hetaryl, hetaryloxy, hetarylthio, where the aryl radicals preferably contain 6 to 10 ring members and the hetaryl radicals 5 or 6 ring members, where the cyclic systems may be partially or fully halogenated or may be substituted by alkyl or haloalkyl groups;
L independently of one another are halogen, C₁-C₆-alkyl, C₁-C₆-haloalkyl, C₁-C₆-alkoxy, C₁-C₆-haloalkoxy, C₂-C₆-alkenyloxy, cyano, C(═O)A¹, S(═O)A², NR^{c}R^{d} or NR^{c}—(C═O)—R^{d}, in which
   A¹ is hydrogen, hydroxyl, C₁-C₈-alkyl, C₁-C₈-alkoxy, C₁-C₈-haloalkoxy, amino, C₁-C₈-alkylamino, di-(C₁-C₈-alkyl)amino, C₂-C₈-alkenyl;
   A² is hydrogen, hydroxyl, C₁-C₈-alkyl, amino, C₁-C₈-alkylamino, di-(C₁-C₈-alkyl)amino;
   R^{c}, R^{d} independently of one another are hydrogen, C₁-C₆-alkyl, C₂-C₁₀-alkenyl, C₂-C₁₀-alkynyl, C₃-C₆-cycloalkyl, C₃-C₈-cycloalkenyl, where the 5 last-mentioned radicals may be partially or fully halogenated or may carry one, two, three or four radicals selected from the group consisting of cyano, C₁-C₄-alkoximino, C₂-C₄-alkenyloximino, C₂-C₄-alkynyloximino and C₁-C₄-alkoxy; and
   m is 0, 1 or 2;
L¹ is halogen, C₁-C₆-alkyl or C₁-C₆-haloalkyl;
L² is nitro, a group —C(S)NR³R⁴, a group —C(═N—OR⁵)(NR⁶R⁷) or a group —C(═N—NR⁸R⁹)(NR¹⁰R¹¹),
X is halogen, cyano, C₁-C₄-alkyl, C₁-C₄-alkoxy, C₁-C₄-haloalkyl or C₁-C₂-haloalkoxy;
R³, R⁴, R⁵, R⁶, R⁷, R⁸, R⁹, R¹⁰ and R¹¹ are independently of one another selected from the group consisting of hydrogen C₁-C₆-alkyl, C₃-C₆-cycloalkyl, C₂-C₆-alkenyl and C₂-C₆-alkynyl, where the 4 last-mentioned radicals may carry one, two, three, four, five or six radicals R^{a}; or
R³ and R⁴, R⁶ and R⁷, R⁸ and R⁹ and/or R¹⁰ and R¹¹ together with the nitrogen atom to which they are attached form a four-, five- or six-membered saturated or partially unsaturated ring which may carry one, two, three, or four substituents independently of one another selected from R^{a}; and
n is 0, 1, 2 or 3
and the agriculturally acceptable salts of the compounds of the formula I.

Accordingly, the present invention provides the use of the triazolopyrimidines of the formula I and their agriculturally acceptable salts for controlling phytopathogenic fungi (=harmful fungi), and a method for controlling phytopathogenic fungi which comprises treating the fungi or the materials, plants, the soil or seed to be protected against fungal attack with an effective amount of a triazolopyrimidine compound of the formula I according to the invention and/or with an agriculturally acceptable salt of I.

The present invention also relates to substituted triazolopyrimidines of the formula I and agriculturally acceptable salts thereof, except for compounds of the formula I in which n is 0 if at the same time L¹ is fluorine or chlorine and L² is a nitro group located in the 4-position.

The present invention furthermore provides a composition for controlling phytopathogenic fungi, which composition comprises at least one compound of the formula I and/or an agriculturally acceptable salt thereof and at least one solid or liquid carrier.

The compounds used according to the invention have better crop plant compatibility and/or higher fungicidal activity than comparable compounds of the prior art.

Depending on the substitution pattern, the compounds of the formula I may have one or more centers of chirality, in which case they are present as enantiomer or diastereomer mixtures. The present invention provides both the pure enantiomers or diastereomers and their mixtures. Suitable compounds of the formula I also comprise all possible stereoisomers (cis/transisomers) and mixtures thereof.

Agriculturally useful salts are especially the salts of those cations or the acid addition salts of those acids whose cations and anions, respectively, have no adverse effect on the fungicidal action of the compounds I. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogensuffate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting I with an acid of the corresponding anion, preferably of hydrochloric acid, hydrobromic acid, sulfuric acid, phosphoric acid or nitric acid.

In the definitions of the substituents given in the formulae above, collective terms are used which are generally representative for the substituents in question. The term Cₙ-Cₘ indicates the number of carbon atoms possible in each case in the substituent or substituent moiety in question:

halogen: fluorine, chlorine, bromine and iodine;

alkyl: saturated straight-chain or branched hydrocarbon radicals having 1 to 4, 6 or 8 carbon atoms, for example C₁-C₆-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl; haloalkyl: straight-chain or branched alkyl groups having 1 or 2, 4, 6 or 8 carbon atoms (as mentioned above), where some or all of the hydrogen atoms in these groups may be replaced by halogen atoms as mentioned above: in particular C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl or 1,1,1-trifluoroprop-2-yl;

alkenyl: unsaturated straight-chain or branched hydrocarbon radicals having 2 to 4, 6 or 8 carbon atoms and one or two double bonds in any position, for example C₂-C₆-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dim ethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;

alkadienyl: doubly unsaturated straight-chain or branched hydrocarbon radicals having 4 to 10 carbon atoms and two double bonds in any position, for example 1,3-butadienyl, 1-methyl-1,3-butadienyl, 2-methyl-1,3-butadienyl, penta-1,3-dien-1-yl, hexa-1,4-dien-1-yl, hexa-1,4-dien-3-yl, hexa-1,4-dien-6-yl, hexa-1,5-dien-1-yl, hexa-1,5-dien-3-yl, hexa-1,5-dien-4-yl, hepta-1,4-dien-1-yl, hepta-1,4-dien-3-yl, hepta-1,4-dien-6-yl, hepta-1,4-dien-7-yl, hepta-1,5-dien-1-yl, hepta-1,5-dien-3-yl, hepta-1,5-dien-4-yl, hepta-1,5-dien-7-yl, hepta-1,6-dien-1-yl, hepta-1,6-dien -3-yl, hepta-1,6-dien-2-yl, hepta-1,6-dien-5-yl, hepta-1,6-dien-2-yl, octa-1,4-dien-1-yl-, octa-1,4-dien -2-yl, octa-1,4-dien-3-yl, octa-1,4-dien-6-yl, octa-1,4-dien-7-yl, octa-1,5-dien-1-yl, octa-1,5-dien-3-yl, octa-1,5-dien-4-yl, octa-1,5-dien-7-yl, octa-1,6-dien-1-yl, octa-1,6-dien-3-yl, octa-1,6-dien-4-yl, octa-1,6-dien-5-yl, octa-1,6-dien-2-yl, deca-1,4-dienyl, deca-1,5-dienyl, deca-1,6-dienyl, deca-1,7-dienyl, deca-1,8-dienyl, deca-2,5-dienyl, deca-2,6-dienyl, deca-2,7-dienyl, deca-2,8-dienyl and the like;

haloalkenyl: unsaturated straight-chain or branched hydrocarbon radicals having 2 to 4, 6, 8 or 10 carbon atoms and one double bond in any position (as mentioned above), where some or all of the hydrogen atoms in these groups may be replaced by halogen atoms as mentioned above, in particular by fluorine, chlorine and bromine;

alkynyl: straight-chain or branched hydrocarbon groups having 2 to 4, 6, 8 or 10 carbon atoms and one or two triple bonds in any position, for example C₂-C₆-alkynyl, such as ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl;

cycloalkyl: mono- or bicyclic saturated hydrocarbon groups having 3 to 6, 8 or 10 carbon ring members, for example C₃-C₈-cycloalkyl, such as cyclopropyl, cyclobutyl, cyclopentyl, cyclohexyl, cycloheptyl, cyclooctyl, bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl and bicyclo[4.4.0]decyl;

cycloalkenyl: monocylic monounsaturated hydrocarbon groups having 3 to 8, preferably 5 to 8, carbon ring members, such as cyclopenten-1-yl, cyclopenten-3-yl, cyclohexen-1-yl, cyclohexen-3-yl and cyclohexen-4-yl;

a five- to ten-membered saturated, partially unsaturated or aromatic heterocycle which contains one, two, three or four heteroatoms from the group consisting of O, N and S:
5- or 6-membered heterocyclyl which contains one, two or three nitrogen atoms and/or one oxygen or sulfur atom or one or two oxygen and/or sulfur atoms, for example 2-tetrahydrofuranyl, 3-tetrahydrofuranyl, 2-tetrahydrothienyl, 3-tetrahydrothienyl, 2-pyrrolidinyl, 3-pyrrolidinyl, 3-isoxazolidinyl, 4-isoxazolidinyl, 5-isoxazolidinyl, 3-isothiazolidinyl, 4-isothiazolidinyl, 5-isothiazolidinyl, 3-pyrazolidinyl, 4-pyrazolidinyl, 5-pyrazolidinyl, 2-oxazolidinyl, 4-oxazolidinyl, 5-oxazolidinyl, 2-thiazolidinyl, 4-thiazolidinyl, 5-thiazolidinyl, 2-imidazolidinyl, 4-imidazolidinyl, 2-pyrrolin-2-yl, 2-pyrrolin-3-yl, 3-pyrrolin-2-yl, 3-pyrrolin-3-yl, 2-piperidinyl, 3-piperidinyl, 4-piperidinyl, 1,3-dioxan-5-yl, 2-tetrahydropyranyl, 4-tetrahydropyranyl, 2-tetrahydrothienyl, 3-hexahydropyridazinyl, 4-hexahydropyridazinyl, 2-hexahydropyrimidinyl, 4-hexahydropyrimidinyl, 5-hexahydropyrimidinyl and 2-piperazinyl;
5-membered heteroaryl which contains one, two, three or four nitrogen atoms or one, two or three nitrogen atoms and one sulfur or oxygen atom: 5-membered heteroaryl groups which, in addition to carbon atoms, may contain one, two, three or four nitrogen atoms or one, two or three nitrogen atoms and one sulfur or oxygen atom as ring members, for example 2-furyl, 3-furyl, 2-thienyl, 3-thienyl, 2-pyrrolyl, 3-pyrrolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, and 1,3,4-triazol-2-yl;
6-membered heteroaryl which contains one, two or three or one, two, three or four nitrogen atoms: 6-membered heteroaryl groups which, in addition to carbon atoms, may contain one, two or three or one, two, three or four nitrogen atoms as ring members, for example 2-pyridinyl, 3-pyridinyl, 4-pyridinyl, 3-pyridazinyl, 4-pyridazinyl, 2-pyrimidinyl, 4-pyrimidinyl, 5-pyrimidinyl and 2-pyrazinyl;

alkylene: divalent unbranched chains of 1 to 6 CH₂ groups, for example CH₂, CH₂CH₂, CH₂CH₂CH₂, CH₂CH₂CH₂CH₂ and CH₂CH₂CH₂CH₂CH₂;

oxyalkylene: divalent unbranched chains of 2 to 4 CH₂ groups where one valency is attached via an oxygen atom to the skeleton, for example OCH₂CH₂, OCH₂CH₂CH₂ and OCH₂CH₂CH₂CH₂;

oxyalkyleneoxy: divalent unbranched chains of 1 to 3 CH₂ groups where both valencies are attached via an oxygen atom to the skeleton, for example OCH₂O, OCH₂CH₂O and OCH₂CH₂CH₂O.

With a view to the activity of the compounds of the formula I according to the invention as fungicides, the substituents A¹, A², X, L, L¹, L², R¹, R², R₃, R⁴, R⁵, R⁶, R⁷, R⁸, R⁹, R¹⁰, R¹¹, R^{c} and R^{d} and the indices n and m independently of one another and preferably in combination preferably have the meanings given below.

Preference is given to compounds of the formula I in which R¹ is not hydrogen.

Particular preference is given to compounds I in which R¹ is C₁-C₆-alkyl, C₂-C₆-alkenyl or C₁-C₈-haloalkyl.

Preference is likewise given to compounds I in which R¹ is a group B: 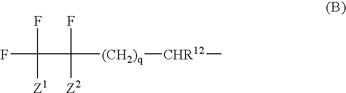
in which

Z¹ is hydrogen, fluorine or C₁-C₆-fluoroalkyl,

Z² is hydrogen or fluorine, or
Z¹ and Z² together form a double bond;

q is 0 or 1; and

R¹² is hydrogen or methyl.

Moreover, preference is given to compounds I in which R¹ is C₃-C₆-cycloalkyl which may be substituted by C₁-C₄-alkyl.

Particularly preferred are compounds I in which R² is hydrogen. Very particular preference is given to compounds I in which R¹ is not hydrogen and R² is hydrogen.

Preference is likewise given to compounds I in which R² is methyl or ethyl.

If R¹ and/or R₂ contain haloalkyl or haloalkenyl groups having a center of chirality, the (S)-isomers are preferred for these groups. In the case of halogen-free alkyl or alkenyl groups having a center of chirality in R¹ or R², preference is given to the (R)configured isomers.

Preference is furthermore given to compounds I in which R¹ and R² together with the nitrogen atom to which they are attached form a piperidinyl, morpholinyl or thiomorpholinyl ring, in particular a piperidinyl ring which is optionally substituted by one to three groups selected from halogen, C₁-C₄-alkyl or C₁-C₄-haloalkyl. Particular preference is given to the compounds in which R¹ and R² together with the nitrogen atom to which they are attached form a 4-methylpiperidine ring.

The invention furthermore preferably provides compounds I in R¹ and R² together with the nitrogen atom to which they are attached form a pyrazole ring which is optionally substituted by one or two groups selected from halogen, C₁-C₄-alkyl or C₁-C₄-haloalkyl, in particular by 2-methyl or 3-methyl.

In addition, particular preference is also given to compounds of the formula I in which R¹ is CH(CH₃)—CH₂CH₃, CH(CH₃)—CH(CH₃)₂, CH(CH₃)—C(CH₃)₃, CH(CH₃)—CF₃, CH₂C(CH₃)═CH₂, CH₂CH═CH₂, cyclopentyl or cyclohexyl; R² is hydrogen or methyl; or R¹ and R² together are —(CH₂)₂CH(CH₃)(CH₂)₂—, —(CH₂)₂CH(CF₃)(CH₂)₂— or —(CH₂)₂O(CH₂)₂—.

Preference is given to compounds I in which X is halogen, C₁-C₄-alkyl, cyano or C₁-C₄-alkoxy, such as chlorine, methyl, cyano, methoxy or ethoxy, especially chlorine or methyl, in particular chlorine.

A preferred embodiment of the invention relates to compounds of the formula I.1: 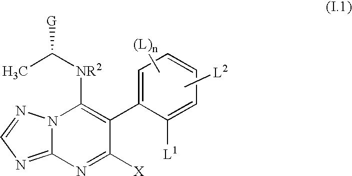
in which
G is C₂-C₆-alkyl, in particular ethyl, n-propyl, isopropyl, n-butyl, sec-butyl, tert-butyl, C₁-C₄-alkoxymethyl, in particular ethoxymethyl, or C₃-C₆-cycloalkyl, in particular cyclopentyl or cyclohexyl;
R₂ is hydrogen or methyl;
X is chlorine, methyl, cyano, methoxy or ethoxy; and
(L)ₙ, L¹, L² are as defined above.

A further preferred embodiment of the invention relates to compounds in which R¹ and R² together with the nitrogen atom to which they are attached form a five-, six- or seven-membered heterocyclyl or heteroaryl which is attached via N and may contain a further heteroatom from the group consisting of O, N and S as ring member and/or may carry one or more substituents from the group consisting of halogen, C₁-C₆-alkyl, C₁-C₆-Haloalkyl, C₂-C₆-alkenyl, C₂-C₆-haloalkenyl, C₁-C₆alkoxy, C₁-C₆-Haloalkoxy, C₃-C₆-alkenyloxy, C₃-C₆-haloalkenyloxy, C₁-C₆-alkylene and oxy-C₁-C₃-alkyleneoxy. These compounds correspond in particular to the formula I.2 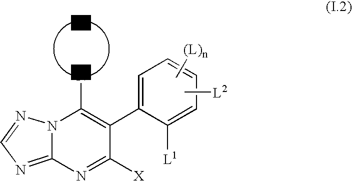
in which
D together with the nitrogen atom forms a five-, six- or seven-membered heterocyclyl or heteroaryl which is attached via N and may contain a further heteroatom from the group consisting of O, N and S as ring member and/or may carry one or more substituents from the group consisting of halogen, C₁-C₄-alkyl, C₁-C₄-alkoxy and C₁-C₂-haloalkyl;
X is chlorine, methyl, cyano, methoxy or ethoxy; and
(L)ₙ, L¹, L² are as defined above.

A further preferred embodiment of the invention relates to compounds of the formula I.3 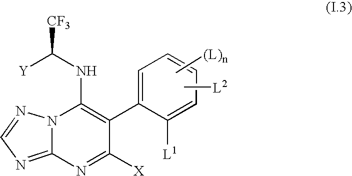
in which:

Y is hydrogen or C₁-C₄-alkyl, in particular methyl and ethyl,
X is chlorine, methyl, cyano, methoxy or ethoxy; and

(L)ₙ, L¹, L² are as defined above.

Preference is given to compounds I in which L is selected from the group consisting of halogen, cyano, C₁-C₆-alkyl, C₁-C₄-haloalkyl, C₁-C₆-alkoxy and C₁-C₆-alkoxycarbonyl.

Particular preference is given to compounds I in which L is selected from the group consisting of fluorine, chlorine, bromine, cyano, C₁-C₄-alkyl, C₁-C₂-haloalkyl, C₁-C₂-alkoxy and C₁-C₂-alkoxycarbonyl.

Especially preferred are compounds I in which L is fluorine, chlorine, C₁-C₂-alkyl, such as methyl or ethyl, C₁-C₂-fluoroalkyl, such as trifluoromethyl, or C₁-C₂-alkoxy, such as methoxy. Special preference is given to compounds I in which L is chlorine or fluorine.

Moreover, preference is given to compounds I where n≠0 in which one of the substituents L is located in the ortho-position relative to the point of attachment to the triazolopyrimidine skeleton. Moreover, particular preference is given to compounds I in which the index n has the value 1 or 2, in particular 1.

Particular preference is likewise given to compounds I in which n has the value 0.

Preference is given to compounds of the formula I in which L¹ is halogen, in particular fluorine or chlorine, or C₁-C₂-alkyl, in particular methyl. Among these, very particular preference is given to compounds I in which L¹ is fluorine or chlorine.

Among the compounds I, particular preference is given to those in which L² is nitro or —C(S)NR³R⁴.

Among the compounds I, very particular preference is given to those in which L² is nitro, L¹ is fluorine, chlorine or methyl and X is chlorine.

In the radical —C(S)NR₃R⁴, R³ and R⁴ are independently of one another preferably selected from the group consisting of hydrogen and C₁-C₆-alkyl. R³ and R⁴ are, independently of one another, selected in particular from the group consisting of H and C₁-C₄-alkyl, such as methyl, ethyl, n-propyl and isopropyl. Moreover, particular preference is given to compounds I in which one of the radicals R³ or R⁴ is hydrogen and the other radical R³ or R⁴ is methyl, ethyl, n-propyl or isopropyl. Moreover, particular preference is given to compounds I in which R³ and R⁴ have the same meaning and are specifically hydrogen, methyl or ethyl.

Particular preference is given to compounds I in which L² is nitro.

In principle, the substituent L² can be located in the 3-, 4-, 5 or 6-position on the phenyl ring. With a view to the fungicidal activity, preference is given to compounds I in which L² located in 4-position (paraposition) relative to the point of attachment to the triazolopyrimidine skeleton.

Preference is likewise given to compounds I in which L² is located in the 5-position relative to the point of attachment to the triazolopyrimidine skeleton. Preference is likewise given to compounds I in which L² is located in the 3-position relative to the point of attachment to the triazolopyrimidine skeleton.

Of the remaining radicals, R₅ is preferably hydrogen or C₁-C₆-alkyl. R⁶ and R⁷ are, independently of one another, preferably hydrogen or C₁-C₆-alkyl. R⁸, R⁹, R¹⁰ and R¹¹ are, independently of one another, preferably selected from the group consisting of hydrogen and C₁-C₆-alkyl.

Furthermore, A¹ is preferably C₁-C₆-alkoxy or amino. A² is preferably hydrogen, C₁-C₆-alkyl or amino. R^{c} and R^{d} are, independently of one another, preferably hydrogen or C₁-C₆-alkyl. The index m is 0, 1 or 2.

With a view to the fungicidal activity of the compounds I according to the invention, L² is preferably nitro. Hereinbelow, such compounds are referred as compounds I.A,

Preference is likewise given to compounds of the formula I in which L² is —C(S)NR³R⁴. Hereinbelow, such compounds are referred to as compounds I.B.

Particular preference is given to triazolopyrimidines of the formulae I.Aa, I.Ab, I.Ac, I.Ad, I.Ba I.Bb, I.Bc and I.Bd 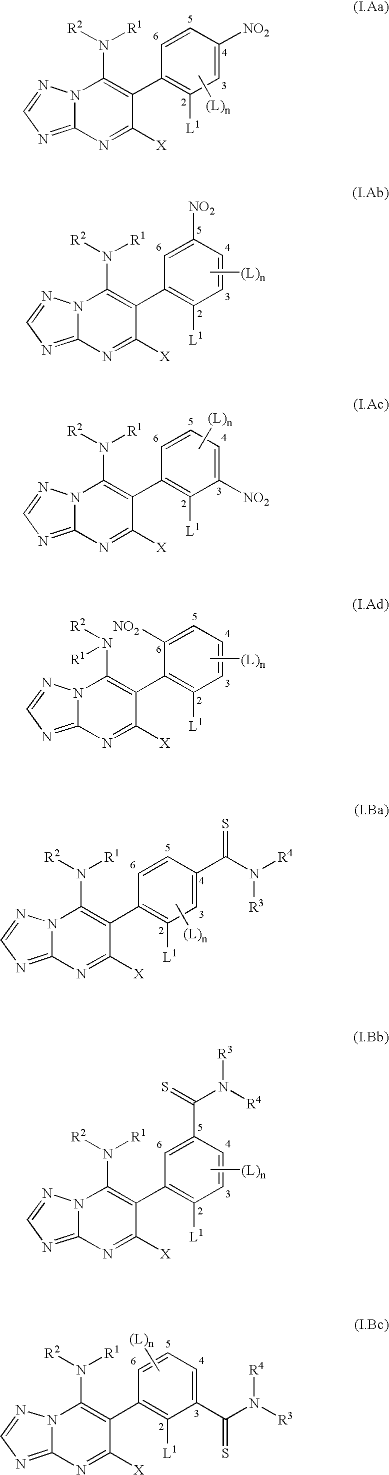 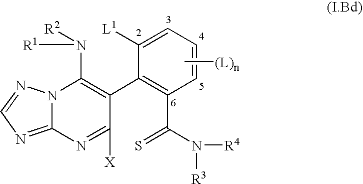
in which the index n and the substituents X, R¹, R² R³, R⁴, L and L¹ have the meanings mentioned above and in particular the following meanings:
R¹, R² are, independently of one another, hydrogen, C₁-C₆-alkyl, C₂-C₆-alkenyl, C₁-C₆-haloalkyl, C₂-C₆-alkynyl, C₄-C₈-cycloalkyl or benzyl;
or R¹ and R² together with the nitrogen atom to which they are attached form a five- to eight-membered heterocyclyl or heteroaryl which may contain one or two further heteroatoms from the group consisting of O, N and S as ring member and/or may carry one, two, three or four substituents selected from the group consisting of halogen, C₁-C₆-alkyl and C₁-C₆-haloalkyl;
R₃, R⁴ are, independently of one another, selected from the group consisting of hydrogen and C₁-C₄-alkyl;
L¹ is halogen or C₁-C₂-alkyl; especially fluorine, chlorine or methyl;
L is halogen, cyano, C₁-C₆-alkyl, C₁-C₆-alkoxy, C₁-C₄-haloalkyl and C₁-C₆-alkoxycarbonyl; for n≠0, L is preferably located in the 4, 5 or 6-position;
X is halogen, cyano, C₁-C₄-alkyl, C₁-C₄-alkoxy; especially halogen;

n is 0 or 1.

In particular with a view to their use as fungicides and active compounds for controlling pests, preference is given to the individual compounds compiled in tables 1 to 180 below, which individual compounds are covered by the general formulae I.Aa, I.Ab, I.Ac, I.Ad, I.Ba, I.Bb, I.Bc and I.Bd. The groups mentioned for a substituent in the tables are furthermore per se, independently of the combination in which they are mentioned, a particularly preferred embodiment of the substituent in question.

Table 1

Compounds of the formulae I.Aa, in which X is chlorine, L¹ is fluorine, n=0 and the combination of R¹ and R² for a compound corresponds in each case to one row of table A.

Table 2

Compounds of the formulae I.Aa, in which X is chlorine, L¹ is fluorine, (L)ₙ is 5-fluoro and the combination of R¹ and R² for a compound corresponds in each case to one row of table A.

Table 3

Compounds of the formulae I.Aa, in which X is chlorine, L¹ is fluorine, (L)ₙ is 5-chloro and the combination of R¹ and R² for a compound corresponds in each case to one row of table A.

Table 4

Compounds of the formulae I.Aa, in which X is chlorine, L¹ is fluorine, (L)ₙ is 5-methyl and the combination of R¹ and R² for a compound corresponds in each case to one row of table A.

Table 5

Compounds of the formulae I.Aa, in which X is chlorine, L¹ is fluorine, (L)ₙ is 5-methoxy and the combination of R¹ and R² for a compound corresponds in each case to one row of table A.

Table 6

Compounds of the formulae I.Aa, in which X is chlorine, L¹ is fluorine, (L)ₙ is 5-cyano and the combination of R¹ and R² for a compound corresponds in each case to one row of table K

Table 7

Compounds of the formulae I.Aa, in which X is chlorine, L¹ is fluorine, (L)ₙ is 5-methoxycarbonyl and the combination of R¹ and R₂ for a compound corresponds in each case to one row of table A.

Table 8

Compounds of the formulae I.Aa, in which X is chlorine, L¹ is chlorine, n=0 and the combination of R¹ and R² for a compound corresponds in each case to one row of table A.

Table 9

Compounds of the formulae I.Aa, in which X is chlorine, L¹ is chlorine (L)ₙ is 5-fluoro and the combination of R¹ and R² for a compound corresponds in each case to one row of table A.

Table 10

Compounds of the formulae I.Aa, in which X is chlorine, L¹ is chlorine, (L)ₙ is 5-chloro and the combination of R¹ and R₂ for a compound corresponds in each case to one row of table A.

Table 11

Compounds of the formulae I.Aa, in which X is chlorine, L¹ is chlorine, (L)ₙ is 5-methyl and the combination of R¹ and R² for a compound corresponds in each case to one row of table A.

Table 12

Compounds of the formulae I.Aa, in which X is chlorine, L¹ is chlorine, (L)ₙ is 5-methoxy and the combination of R¹ and R² for a compound corresponds in each case to one row of table A.

Table 13

Compounds of the formulae I.Aa, in which X is chlorine, L¹ is chlorine, (L)ₙ is 5-cyano and the combination of R¹ and R² for a compound corresponds in each case to one row of table A.

Table 14

Compounds of the formulae I.Aa, in which X is chlorine, L¹ is chlorine, (L)ₙ is 5-methoxycarbonyl and the combination of R¹ and R² for a compound corresponds in each case to one row of table A.

Table 15

Compounds of the formulae I.Aa, in which X is chlorine, L¹ is methyl, n=0 and the combination of R¹ and R² for a compound corresponds in each case to one row of table

Table 16

Compounds of the formulae I.Aa, in which X is chlorine, L¹ is methyl, (L)ₙ is 5-fluoro and the combination of R¹ and R² for a compound corresponds in each case to one row of table A.

Table 17

Compounds of the formulae I.Aa, in which X is chlorine, L¹ is methyl, (L)ₙ is 5-chloro and the combination of R¹ and R² for a compound corresponds in each case to one row of table A.

Table 18

Compounds of the formulae I.Aa, in which X is chlorine, L¹ is methyl, (L)ₙ is 5-methyl and the combination of R¹ and R² for a compound corresponds in each case to one row of table A.

Table 19

Compounds of the formulae I.Aa, in which X is chlorine, L¹ is methyl, (L)ₙ is 5-methoxy and the combination of R¹ and R² for a compound corresponds in each case to one row of table A.

Table 20

Compounds of the formulae I.Aa, in which X is chlorine, L¹ is methyl, (L)ₙ is 5-cyano and the combination of R¹ and R² for a compound corresponds in each case to one row of table A.

Table 21

Compounds of the formulae I.Aa, in which X is chlorine, L¹ is methyl, (L)ₙ is 5-methoxycarbonyl and the combination of R¹ and R² for a compound corresponds in each case to one row of table A.

Table 22

Compounds of the formulae I.Ab, in which X is chlorine, L¹ is fluorine, n=0 and the combination of R¹ and R² for a compound corresponds in each case to one row of table A.

Table 23

Compounds of the formulae I.Ab, in which X is chlorine, L¹ is fluorine, (L)ₙ is 4-fluoro and the combination of R¹ and R² for a compound corresponds in each case to one row of table A.

Table 24

Compounds of the formulae I.Ab, in which X is chlorine, L¹ is fluorine, (L)ₙ is 4-chloro and the combination of R¹ and R² for a compound corresponds in each case to one row of table A.

Table 25

Compounds of the formulae I.Ab, in which X is chlorine, L¹ is fluorine, (L)ₙ is 4-methyl and the combination of R¹ and R² for a compound corresponds in each case to one row of table A.

Table 26

Compounds of the formulae I.Ab, in which X is chlorine, L¹ is fluorine, (L)ₙ is 4-methoxy and the combination of R¹ and R² for a compound corresponds in each case to one row of table A.

Table 27

Compounds of the formulae I.Ab, in which X is chlorine, L¹ is fluorine, (L)ₙ is 4-cyano and the combination of R¹ and R² for a compound corresponds in each case to one row of table A.

Table 28

Compounds of the formulae I.Ab, in which X is chlorine, L¹ is fluorine, (L)ₙ is 4-methoxycarbonyl and the combination of R¹ and R² for a compound corresponds in each case to one row of table A.

Table 29

Compounds of the formulae I.Ab, in which X is chlorine, L¹ is chlorine, n=0 and the combination of R¹ and R² for a compound corresponds in each case to one row of table A.

Table 30

Compounds of the formulae I.Ab, in which X is chlorine, L¹ is chlorine, (L)ₙ is 4-fluoro and the combination of R¹ and R² for a compound corresponds in each case to one row of table A.

Table 31

Compounds of the formulae I.Ab, in which X is chlorine, L¹ is chlorine, (L)ₙ in 4-chloro and the combination of R¹ and R² for a compound corresponds in each case to one row of table A.

Table 32

Compounds of the formulae I.Ab, in which X is chlorine, L¹ is chlorine, (L)ₙ is 4-methyl and the combination of R¹ and R² for a compound corresponds in each case to one row of table A.

Table 33

Compounds of the formulae I.Ab, in which X is chlorine, L¹ is chlorine, (L)ₙ is 4-methoxy and the combination of R¹ and R² for a compound corresponds in each case to one row of table A.

Table 34

Compounds of the formulae I.Ab, in which X is chlorine, L¹ is chlorine, (L)ₙ is 4-cyano and the combinahon of R¹ and R² for a compound corresponds in each case to one row of table A.

Table 35

Compounds of the formulae I.Ab, in which X is chlorine, L¹ is chlorine, (L)ₙ is 4-methoxycarbonyl and the combination of R¹ and R² for a compound corresponds in each case to one row of table A.

Table 36

Compounds of the formulae I.Ab, in which X is chlorine, L¹ is methyl, n=0 and the combination of R¹ and R² for a compound corresponds in each case to one row of table A.

Table 37

Compounds of the formulae I.Ab, in which X is chlorine, L¹ is methyl, (L)ₙ is 4-fluoro and the combination of R¹ and R² for a compound corresponds in each case to one row of table A.

Table 38

Compounds of the formulae I.Ab, in which X is chlorine, L¹ is methyl, (L)ₙ is 4-chloro and the combination of R¹ and R² for a compound corresponds in each case to one row of table A.

Table 39

Compounds of the formulae I.Ab, in which X is chlorine, L¹ is methyl, (L)ₙ is 4-methyl and the combination of R¹ and R² for a compound corresponds in each case to one row of table A.

Table 40

Compounds of the formulae I.Ab, in which X is chlorine, L¹ is methyl, (L)ₙ is 4-methoxy and the combination of R¹ and R² for a compound corresponds in each case to one row of table A.

Table 41

Compounds of the formulae I.Ab, in which X is chlorine, L¹ is methyl, (L)ₙ is 4-cyano and the combination of R¹ and R² for a compound corresponds in each case to one row of table A.

Table 42

Compounds of the formulae I.Ab, in which X is chlorine, L¹ is methyl, (L)ₙ is 4-methoxycarbonyl and the combination of R¹ and R² for a compound corresponds in each case to one row of table A.

Table 43

Compounds of the formulae I.Aa, I.Ab, I.Ac and I.Ad, in which X is cyano, L¹ is chlorine, n=0 and the combination of R¹ and R² for a compound corresponds in each case to one row of table A.

Table 44

Compounds of the formulae I.Aa, I.Ab, I.Ac and I.Ad, in which X is methyl, L¹ is chlorine, n=0 and the combination of R¹ and R² for a compound corresponds in each case to one row of table A.

Table 45

Compounds of the formulae I.Aa, I.Ab, I.Ac and I.Ad, in which X is methoxy, L¹ is chlorine, n=0 and the combination of R¹ and R² for a compound corresponds in each case to one row of table A.

Table 46

Compounds of the formulae I.Aa, I.Ab, I.Ac and I.Ad, in which X is cyano, L¹ is fluorine, n=0 and the combination of R¹ and R² for a compound corresponds in each case to one row of table A.

Table 47

Compounds of the formulae I.Aa, I.Ab, I.Ac and I.Ad, in which X is methyl, L¹ is fluorine, n=0 and the combination of R¹ and R² for a compound corresponds in each case to one row of table A.

Table 48

Compounds of the formulae I.Aa, I.Ab, I.Ac and I.Ad, in which X is methoxy, L¹ is fluorine, n=0 and the combination of R¹ and R² for a compound corresponds in each case to one row of table A.

Table 49

Compounds of the formulae I.Aa, I.Ab and I.Ac, in which X is chlorine, L¹ is chlorine, (L)ₙ is 6-fluoro and the combination of R¹ and R² for a compound corresponds in each case to one row of table A.

Table 50

Compounds of the formulae I.Aa, I.Ab and I.Ac, in which X is cyano, L¹ is chlorine, (L)ₙ is 6-fluoro and the combination of R¹ and R² for a compound corresponds in each case to one row of table A.

Table 51

Compounds of the formulae I.Aa, I.Ab and I.Ac, in which X is methyl, L¹ is chlorine, (L)ₙ is 6-fluoro and the combination of R¹ and R² for a compound corresponds in each case to one row of table A.

Table 52

Compounds of the formulae I.Aa, I.Ab and I.Ac, in which X is methoxy, L¹ is chlorine, (L)ₙ is 6-fluoro and the combination of R¹ and R² for a compound corresponds in each case to one row of table A.

Table 53

Compounds of the formulae I.Aa, I.Ab and I.Ac, in which X is chlorine, L¹ is chlorine, (L)ₙ is 6-chloro and the combination of R¹ and R² for a compound corresponds in each case to one row of table A.

Table 54

Compounds of the formulae I.Aa, I.Ab and I.Ac, in which X is cyano, L¹ is chlorine, (L)ₙ is 6-chloro and the combination of R¹ and R² for a compound corresponds in each case to one row of table A.

Table 55

Compounds of the formulae I.Aa, I.Ab and I.Ac, in which X is methyl, L¹ is chlorine, (L)ₙ is 6-chloro and the combination of R¹ and R² for a compound corresponds in each case to one row of table A.

Table 56

Compounds of the formulae I.Aa, I.Ab and I.Ac, in which X is methoxy, L¹ is chlorine, (L)ₙ is &chloro and the combination of R¹ and R² for a compound corresponds in each case to one row of table A.

Table 57

Compounds of the formulae I.Aa, I.Ab and I.Ac, in which X is chlorine, L¹ is fluorine, (L)ₙ is 6-fluoro and the combination of R¹ and R² for a compound corresponds in each case to one row of table A.

Table 58

Compounds of the formulae I.Aa, I.Ab and I.Ac, in which X is cyano, L¹ is fluorine, (L)ₙ is 6-fluoro and the combination of R¹ and R² for a compound corresponds in each case to one row of table A.

Table 59

Compounds of the formulae I.Aa, I.Ab and I.Ac, in which X is methyl, L¹ is fluorine, (L)ₙ is 6-fluoro and the combination of R¹ and R² for a compound corresponds in each case to one row of table A.

Table 60

Compounds of the formulae I.Aa, I.Ab and I.Ac, in which X is methoxy, L¹ is fluorine, (L)ₙ is 6-fluoro and the combination of R¹ and R² for a compound corresponds in each case to one row of table A.

Table 61

Compounds of the formulae I.Ba, in which X is chlorine, L¹ is fluorine, n=0, R³ and R⁴ are each hydrogen and the combination of R¹ and R² for a compound corresponds in each case to one row of table A.

Table 62

Compounds of the formulae I.Ba, in which X is chlorine, L¹ is fluorine, (L)ₙ is 5-fluoro, R³ and R⁴ are each hydrogen and the combination of R¹ and R² for a compound corresponds in each case to one row of table A.

Table 63

Compounds of the formulae I.Ba, in which X is chlorine, L¹ is fluorine, (L)ₙ 5-chloro, R³ and R⁴ are each hydrogen and the combination of R¹ and R² for a compound corresponds in each case to one row of table A.

Table 64

Compounds of the formulae I.Ba, in which X is chlorine, L¹ is fluorine, (L)ₙ is 5-methyl, R³ and R⁴ are each hydrogen and the combination of R¹ and R² for a compound corresponds in each case to one row of table A.

Table 65

Compounds of the formulae I.Ba, in which X is chlorine, L¹ is fluorine, (L)ₙ is 5-methoxy, R³ and R⁴ are each hydrogen and the combination of R¹ and R² for a compound corresponds in each case to one row of table A.

Table 66

Compounds of the formulae I.Ba, in which X is chlorine, L¹ is fluorine, (L)ₙ is 5-cyano,

R³ and R⁴ are each hydrogen and the combination of R¹ and R² for a compound corresponds in each case to one row of table A.

Table 67

Compounds of the formulae I.Ba, in which X is chlorine, L¹ is fluorine, (L)ₙ is 5-methoxycarbonyl, R³ and R⁴ are each hydrogen and the combination of R¹ and R² for a compound corresponds in each case to one row of table A.

Table 68

Compounds of the formulae I.Ba, in which X is chlorine, L¹ is chlorine, n=0, R³ and R⁴ are each hydrogen and the combination of R¹ and R² for a compound corresponds in each case to one row of table A.

Table 69

Compounds of the formulae I.Ba, in which X is chlorine, L¹ is chlorine, (L)ₙ is 5-fluoro, R³ and R⁴ are each hydrogen and the combination of R¹ and R² for a compound corresponds in each case to one row of table A.

Table 70

Compounds of the formulae I.Ba, in which X is chlorine, L¹ is chlorine, (L)ₙ is 5-chloro, R₃ and R⁴ are each hydrogen and the combination of R¹ and R² for a compound corresponds in each case to one row of table A.

Table 71

Compounds of the formulae I.Ba, in which X is chlorine, L¹ is chlorine, (L)ₙ is 5-methyl, R³ and R⁴ are each hydrogen and the combination of R¹ and R² for a compound corresponds in each case to one row of table A.

Table 72

Compounds of the formulae I.Ba, in which X is chlorine, L¹ is chlorine, (L)ₙ is 5-methoxy, R³ and R⁴ are each hydrogen and the combination of R¹ and R² for a compound corresponds in each case to one row of table A.

Table 73

Compounds of the formulae I.Ba, in which X is chlorine, L¹ is chlorine, (L)ₙ is 5-cyano, R³ and R⁴ are each hydrogen and the combination of R¹ and R² for a compound corresponds in each case to one row of table A.

Table 74

Compounds of the formulae I.Ba, in which X is chlorine, L¹ is chlorine, (L)ₙ is 5-methoxycarbonyl, R³ and R⁴ are each hydrogen and the combination of R¹ and R² for a compound corresponds in each case to one row of table A.

Table 75

Compounds of the formulae I.Ba, in which X is chlorine, L¹ is methyl, n=0, R³ and R⁴ are each hydrogen and the combination of R¹ and R² for a compound corresponds in each case to one row of table A.

Table 76

Compounds of the formulae I.Ba, in which X is chlorine, L¹ is methyl, (L)ₙ is 5-fluoro, R³ and R⁴ are each hydrogen and the combination of R¹ and R² for a compound corresponds in each case to one row of table A.

Table 77

Compounds of the formulae I.Ba, in which X is chlorine, L¹ is methyl, (L)ₙ is 5-chloro, R³ and R⁴ are each hydrogen and the combination of R¹ and R² for a compound corresponds in each case to one row of table A.

Table 78

Compounds of the formulae I.Ba, in which X is chlorine, L¹ is methyl, (L)ₙ is 5-methyl, R³ and R⁴ are each hydrogen and the combination of R¹ and R² for a compound corresponds in each case to one row of table A.

Table 79

Compounds of the formulae I.Ba, in which X is chlorine, L¹ is methyl, (L)ₙ is 5-methoxy, R³ and R⁴ are each hydrogen and the combination of R¹ and R² for a compound corresponds in each case to one row of table A.

Table 80

Compounds of the formulae I.Ba, in which X is chlorine, L¹ is methyl, (L)ₙ is 5-cyano, R³ and R⁴ are each hydrogen and the combination of R¹ and R² for a compound corresponds in each case to one row of table A.

Table 81

Compounds of the formulae I.Ba, in which X is chlorine, L¹ is methyl, (L)ₙ is 5-methoxycarbonyl, R³ and R⁴ are each hydrogen and the combination of R¹ and R² for a compound corresponds in each case to one row of table A.

Table 82

Compounds of the formulae I.Bb, in which X is chlorine, L¹ is fluorine, n=0, R³ and R⁴ are each hydrogen and the combination of R¹ and R² for a compound corresponds in each case to one row of table A.

Table 83

Compounds of the formulae I.Bb, in which X is chlorine, L¹ is fluorine, (L)ₙ is 4-fluoro, R³ and R⁴ are each hydrogen and the combination of R¹ and R² for a compound corresponds in each case to one row of table A.

Table 84

Compounds of the formulae I.Bb, in which X is chlorine, L¹ is fluorine, (L)ₙ is 4-chloro, R³ and R⁴ are each hydrogen and the combination of R¹ and R² for a compound corresponds in each case to one row of table A.

Table 85

Compounds of the formulae I.Bb, in which X is chlorine, L¹ is fluorine, (L)ₙ is 4-methyl, R³ and R⁴ are each hydrogen and the combination of R¹ and R² for a compound corresponds in each case to one row of table A.

Table 86

Compounds of the formulae I.Bb, in which X is chlorine, L¹ is fluorine, (L)ₙ is 4-methoxy, R³ and R⁴ are each hydrogen and the combination of R¹ and R² for a compound corresponds in each case to one row of table A.

Table 87

Compounds of the formulae I.Bb, in which X is chlorine, L¹ is fluorine, (L)ₙ is 4-cyano, R³ and R⁴ are each hydrogen and the combination of R¹ and R² for a compound corresponds in each case to one row of table A.

Table 88

Compounds of the formulae I.Bb, in which X is chlorine, L¹ is fluorine, (L)ₙ is 4-methoxycarbonyl, R³ and R⁴ are each hydrogen and the combination of R¹ and R² for a compound corresponds in each case to one row of table A.

Table 89

Compounds of the formulae I.Bb, in which X is chlorine, L¹ is chlorine, n=0, R³ and R⁴ are each hydrogen and the combination of R¹ and R² for a compound corresponds in each case to one row of table A.

Table 90

Compounds of the formulae I.Bb, in which X is chlorine, L¹ is chlorine, (L)ₙ is 4-fluoro, R³ and R⁴ are each hydrogen and the combination of R¹ and R² for a compound corresponds in each case to one row of table A.

Table 91

Compounds of the formulae I.Bb, in which X is chlorine, L¹ is chlorine, (L)ₙ 4-chloro, R³ and R⁴ are each hydrogen and the combination of R¹ and R² for a compound corresponds in each case to one row of table A.

Table 92

Compounds of the formulae I.Bb, in which X is chlorine, L¹ is chlorine, (L)ₙ is 4-methyl, R³ and R⁴ are each hydrogen and the combination of R¹ and R² for a compound corresponds in each case to one row of table A.

Table 93

Compounds of the formulae I.Bb, in which X is chlorine, L¹ is chlorine, (L)ₙ is 4-methoxy, R³ and R⁴ are each hydrogen and the combination of R¹ and R² for a compound corresponds in each case to one row of table A.

Table 94

Compounds of the formulae I.Bb, in which X is chlorine, L¹ is chlorine, (L)ₙ is 4-cyano, R³ and R⁴ are each hydrogen and the combination of R¹ and R² for a compound corresponds in each case to one row of table A.

Table 95

Compounds of the formulae I.Bb, in which X is chlorine, L¹ is chlorine, (L)ₙ is 4-methoxycarbonyl, R³ and R⁴ are each hydrogen and the combination of R¹ and R² for a compound corresponds in each case to one row of table A.

Table 96

Compounds of the formulae I.Bb, in which X is chlorine, L¹ is methyl, n=0, R³ and R⁴ are each hydrogen and the combination of R¹ and R² for a compound corresponds in each case to one row of table A.

Table 97

Compounds of the formulae I.Bb, in which X is chlorine, L¹ is methyl, (L)ₙ is 4-fluoro, R³ and R⁴ are each hydrogen and the combination of R¹ and R² for a compound corresponds in each case to one row of table A.

Table 98

Compounds of the formulae I.Bb, in which X is chlorine, L¹ is methyl, (L)ₙ is 4-chloro, R³ and R⁴ are each hydrogen and the combination of R¹ and R² for a compound corresponds in each case to one row of table A.

Table 99

Compounds of the formulae I.Bb, in which X is chlorine, L¹ is methyl, (L)ₙ is 4-methyl, R³ and R⁴ are each hydrogen and the combination of R¹ and R² for a compound corresponds in each case to one row of table A.

Table 100

Compounds of the formulae I.Bb, in which X is chlorine, L¹ is methyl, (L)ₙ is 4-methoxy, R³ and R⁴ are each hydrogen and the combination of R¹ and R² for a compound corresponds in each case to one row of table A.

Table 101

Compounds of the formulae I.Bb, in which X is chlorine, L¹ is methyl, (L)ₙ is 4-cyano, R³ and R⁴ are each hydrogen and the combination of R¹ and R² for a compound corresponds in each case to one row of table A.

Table 102

Compounds of the formulae I.Bb, in which X is chlorine, L¹ is methyl, (L)ₙ is 4-methoxycarbonyl, R³ and R⁴ are each hydrogen and the combination of R¹ and R² for a compound corresponds in each case to one row of table A.

Table 103

Compounds of the formulae I.Ba, I.Bb, I.Bc and I.Bd, in which X is cyano, L¹ is chlorine, n=0, R³ and R⁴ are each hydrogen and the combination of R¹ and R² for a compound corresponds in each case to one row of table A.

Table 104

Compounds of the formulae I.Ba, I.Bb, I.Bc and I.Bd, in which X is methyl, L¹ is chlorine, n=0, R³ and R⁴ are each hydrogen and the combination of R¹ and R² for a compound corresponds in each case to one row of table A.

Table 105

Compounds of the formulae I.Ba, I.Bb, I.Bc and I.Bd, in which X is methoxy, L¹ is chlorine, n=0, R³ and R⁴ are each hydrogen and the combination of R¹ and R² for a compound corresponds in each case to one row of table A.

Table 106

Compounds of the formulae I.Ba, I.Bb, I.Bc and I.Bd, in which X is cyano, L¹ is fluorine, n=0, R³ and R⁴ are each hydrogen and the combination of R¹ and R² for a compound corresponds in each case to one row of table A.

Table 107

Compounds of the formulae I.Ba, I.Bb, I.Bc and I.Bd, in which X is methyl, L¹ is fluorine, n=0, R³ and R⁴ are each hydrogen and the combination of R¹ and R² for a compound corresponds in each case to one row of table A.

Table 108

Compounds of the formulae I.Ba, I.Bb, I.Bc and I.Bd, in which X is methoxy, L¹ is fluorine, n=0, R³ and R⁴ are each hydrogen and the combination of R¹ and R² for a compound corresponds in each case to one row of table A.

Table 109

Compounds of the formulae I.Ba, I.Bb and I.Bc, in which X is chlorine, L¹ is chlorine, (L)ₙ is 6-fluoro, R³ and R⁴ are each hydrogen and the combination of R¹ and R² for a compound corresponds in each case to one row of table A.

Table 110

Compounds of the formulae I.Ba, I.Bb and I.Bc, in which X is cyano, L¹ is chlorine, (L)ₙ is 6-fluoro, R³ and R⁴ are each hydrogen and the combination of R¹ and R² for a compound corresponds in each case to one row of table A.

Table 111

Compounds of the formulae I.Ba, I.Bb and I.Bc, in which X is methyl, L¹ is chlorine, (L)ₙ is 6-fluoro, R³ and R⁴ are each hydrogen and the combination of R¹ and R² for a compound corresponds in each case to one row of table A.

Table 112

Compounds of the formulae I.Ba, I.Bb and I.Bc, in which X is methoxy, L¹ is chlorine, (L)ₙ is 6-fluoro, R³ and R⁴ are each hydrogen and the combination of R¹ and R² for a compound corresponds in each case to one row of table A.

Table 113

Compounds of the formulae I.Ba, I.Bb and I.Bc, in which X is chlorine, L¹ is chlorine, (L)ₙ is 6-chloro, R³ and R⁴ are each hydrogen and the combination of R¹ and R² for a compound corresponds in each case to one row of table A.

Table 114

Compounds of the formulae I.Ba, I.Bb and I.Bc, in which X is cyano, L¹ is chlorine, (L)ₙ is 6-chloro, R³ and R⁴ are each hydrogen and the combination of R¹ and R² for a compound corresponds in each case to one row of table A.

Table 115

Compounds of the formulae I.Ba, I.Bb and I.Bc, in which X is methyl, L¹ is chlorine, (L)ₙ is 6-chloro, R³ and R⁴ are each hydrogen and the combination of R¹ and R² for a compound corresponds in each case to one row of table A.

Table 116

Compounds of the formulae I.Ba, I.Bb and I.Bc, in which X is methoxy, L¹ is chlorine, (L)ₙ is 6-chloro, R³ and R⁴ are each hydrogen and the combination of R¹ and R² for a compound corresponds in each case to one row of table A.

Table 117

Compounds of the formulae I.Ba, I.Bb and I.Bc, in which X is chlorine, L¹ is fluorine, (L)ₙ is 6-fluoro, R³ and R⁴ are each hydrogen and the combination of R¹ and R² for a compound corresponds in each case to one row of table A.

Table 118

Compounds of the formulae I.Ba, I.Bb and I.Bc, in which X is cyano, L¹ is fluorine, (L)ₙ is 6-fluoro, R³ and R⁴ are each hydrogen and the combination of R¹ and R² for a compound corresponds in each case to one row of table A.

Table 119

Compounds of the formulae I.Ba, I.Bb and I.Bc, in which X is methyl, L¹ is fluorine, (L)ₙ is 6-fluoro, R³ and R⁴ are each hydrogen and the combination of R¹ and R² for a compound corresponds in each case to one row of table A.

Table 120

Compounds of the formulae I.Ba, I.Bb and I.Bc, in which X is methoxy, L¹ is fluorine, (L)ₙ is 6-fluoro, R³ and R⁴ are each hydrogen and the combination of R¹ and R² for a compound corresponds in each case to one row of table A.

Table 121

Compounds of the formulae I.Ba, I.Bb, I.Bc and I.Bd, in which X is chlorine, L¹ is chlorine, n=0, R³ and R⁴ are each methyl and the combination of R¹ and R² for a compound corresponds in each case to one row of table A.

Table 122

Compounds of the formulae I.Ba, I.Bb, I.Bc and I.Bd, in which X is cyano, L¹ is chlorine, n=0, R³ and R⁴ are each methyl and the combination of R¹ and R² for a compound corresponds in each case to one row of table A.

Table 123

Compounds of the formulae I.Ba, I.Bb, I.Bc and I.Bd, in which X is methyl, L¹ is chlorine, n=0, R³ and R⁴ are each methyl and the combination of R¹ and R² for a compound corresponds in each case to one row of table A.

Table 124

Compounds of the formulae I.Ba, I.Bb, I.Bc and I.Bd, in which X is methoxy, L¹ is chlorine, n=0, R³ and R⁴ are each methyl and the combination of R¹ and R² for a compound corresponds in each case to one row of table A.

Table 125

Compounds of the formulae I.Ba, I.Bb, I.Bc and I.Bd, in which X is chlorine, L¹ is fluorine, n=0, R³ and R⁴ are each methyl and the combination of R¹ and R² for a compound corresponds in each case to one row of table A.

Table 126

Compounds of the formulae I.Ba, I.Bb, I.Bc and I.Bd, in which X is cyano, L¹ is fluorine, n=0, R³ and R⁴ are each methyl and the combination of R¹ and R² for a compound corresponds in each case to one row of table A.

Table 127

Compounds of the formulae I.Ba, I.Bb, I.Bc and I.Bd, in which X is methyl, L¹ is fluorine, n=0, R³ and R⁴ are each methyl and the combination of R¹ and R² for a compound corresponds in each case to one row of table A.

Table 128

Compounds of the formulae I.Ba, I.Bb, I.Bc and I.Bd, in which X is methoxy, L¹ is fluorine, n=0, R³ and R⁴ are each methyl and the combination of R¹ and R² for a compound corresponds in each case to one row of table A.

Table 129

Compounds of the formulae I.Ba, I.Bb and I.Bc, in which X is chlorine, L¹ is chlorine, (L)ₙ is 6-fluoro, R³ and R⁴ are each methyl and the combination of R¹ and R² for a compound corresponds in each case to one row of table A.

Table 130

Compounds of the formulae I.Ba, I.Bb and I.Bc, in which X is cyano, L¹ is chlorine, (L)ₙ is 6-fluoro, R³ and R⁴ are each methyl and the combination of R¹ and R² for a compound corresponds in each case to one row of table A.

Table 131

Compounds of the formulae I.Ba, I.Bb and I.Bc, in which X is methyl, L¹ is chlorine, (L)ₙ is 6-fluoro, R³ and R⁴ are each methyl and the combination of R¹ and R² for a compound corresponds in each case to one row of table A.

Table 132

Compounds of the formulae I.Ba, I.Bb and I.Bc, in which X is methoxy, L¹ is chlorine, (L)ₙ is 6-fluoro, R³ and R⁴ are each methyl and the combination of R¹ and R² for a compound corresponds in each case to one row of table A.

Table 133

Compounds of the formulae I.Ba, I.Bb and I.Bc, in which X is chlorine, L¹ is chlorine, (L)ₙ is 6-chloro, R³ and R⁴ are each methyl and the combination of R¹ and R² for a compound corresponds in each case to one row of table A.

Table 134

Compounds of the formulae I.Ba, I.Bb and I.Bc, in which X is cyano, L¹ is chlorine, (L)ₙ is 6-chloro, R³ and R⁴ are each methyl and the combination of R¹ and R² for a compound corresponds in each case to one row of table A.

Table 135

Compounds of the formulae I.Ba, I.Bb and I.Bc, in which X is methyl, L¹ is chlorine, (L)ₙ is 6-chloro, R³ and R⁴ are each methyl and the combination of R¹ and R² for a compound corresponds in each case to one row of table A.

Table 136

Compounds of the formulae I.Ba, I.Bb and I.Bc, in which X is methoxy, L¹ is chlorine, (L)ₙ is 6-chloro, R³ and R⁴ are each methyl and the combination of R¹ and R² for a compound corresponds in each case to one row of table A.

Table 137

Compounds of the formulae I.Ba, I.Bb and I.Bc, in which X is chlorine, L¹ is fluorine, (L)ₙ is 6-fluoro, R³ and R⁴ are each methyl and the combination of R¹ and R² for a compound corresponds in each case to one row of table A.

Table 138

Compounds of the formulae I.Ba, I.Bb and I.Bc, in which X is cyano, L¹ is fluorine, (L)ₙ is 6-fluoro, R³ and R⁴ are each methyl and the combination of R¹ and R² for a compound corresponds in each case to one row of table A.

Table 139

Compounds of the formulae I.Ba, I.Bb and I.Bc, in which X is methyl, L¹ is fluorine, (L)ₙ is 6-fluoro, R³ and R⁴ are each methyl and the combination of R¹ and R² for a compound corresponds in each case to one row of table A.

Table 140

Compounds of the formulae I.Ba, I.Bb and I.Bc, in which X is methoxy, L¹ is fluorine, (L)ₙ is 6-fluoro, R³ and R⁴ are each methyl and the combination of R¹ and R² for a compound corresponds in each case to one row of table A.

Table 141

Compounds of the formulae I.Ba, I.Bb, I.Bc and I.Bd, in which X is chlorine, L¹ is chlorine, n=0, R³ is methyl, R⁴ is hydrogen and the combination of R¹ and R² for a compound corresponds in each case to one row of table A.

Table 142

Compounds of the formulae I.Ba, I.Bb, I.Bc and I.Bd, in which X is cyano, L¹ is chlorine, n=0, R³ is methyl, R⁴is hydrogen and the combination of R¹ and R² for a compound corresponds in each case to one row of table A.

Table 143

Compounds of the formulae I.Ba, I.Bb, I.Bc and I.Bd, in which X is methyl, L¹ is chlorine, n=0, R³ is methyl, R⁴is hydrogen and the combination of R¹ and R² for a compound corresponds in each case to one row of table A.

Table 144

Compounds of the formulae I.Ba, I.Bb, I.Bc and I.Bd, in which X is methoxy, L¹ is chlorine, n=0, R³ is methyl, R⁴ is hydrogen and the combination of R¹ and R² for a compound corresponds in each case to one row of table A.

Table 145

Compounds of the formulae I.Ba, I.Bb, I.Bc and I.Bd, in which X is chlorine, L¹ is fluorine, n=0, R³ is methyl, R⁴ is hydrogen and the combination of R¹ and R² for a compound corresponds in each case to one row of table A.

Table 146

Compounds of the formulae I.Ba, I.Bb, I.Bc and I.Bd, in which X is cyano, L¹ is fluorine, n=0, R³ is methyl, R⁴ is hydrogen and the combination of R¹ and R² for a compound corresponds in each case to one row of table A.

Table 147

Compounds of the formulae I.Ba, I.Bb, I.Bc and I.Bd, in which X is methyl, L¹ is fluorine, n=0, R³ is methyl, R⁴ is hydrogen and the combination of R¹ and R² for a compound corresponds in each case to one row of table A.

Table 148

Compounds of the formulae I.Ba, I.Bb, I.Bc and I.Bd, in which X is methoxy, L¹ is fluorine, n=0, R³ is methyl, R⁴ is hydrogen and the combination of R¹ and R² for a compound corresponds in each case to one row of table A.

Table 149

Compounds of the formulae I.Ba, I.Bb and I.Bc, in which X is chlorine, L¹ is chlorine, (L)ₙ is 6-fluoro, R³ is methyl, R⁴ is hydrogen and the combination of R¹ and R² for a compound corresponds in each case to one row of table A.

Table 150

Compounds of the formulae I.Ba, I.Bb and I.Bc, in which X is cyano, L¹ is chlorine, (L)ₙ is 6-fluoro, R³ is methyl, R⁴ is hydrogen and the combination of R¹ and R² for a compound corresponds in each case to one row of table A.

Table 151

Compounds of the formulae I.Ba, I.Bb and I.Bc, in which X is methyl, L¹ is chlorine, (L)ₙ is 6-fluoro, R³ is methyl, R⁴ is hydrogen and the combination of R¹ and R² for a compound corresponds in each case to one row of table A.

Table 152

Compounds of the formulae I.Ba, I.Bb and I.Bc, in which X is methoxy, L¹ is chlorine, (L)ₙ is 6-fluoro, R³ is methyl, R⁴ is hydrogen and the combination of R¹ and R² for a compound corresponds in each case to one row of table A.

Table 153

Compounds of the formulae I.Ba, I.Bb and I.Bc, in which X is chlorine, L¹ is chlorine, (L)ₙ is 6chloro, R³ is methyl, R⁴ is hydrogen and the combination of R¹ and R² for a compound corresponds in each case to one row of table A.

Table 154

Compounds of the formulae I.Ba, I.Bb and I.Bc, in which X is cyano, L¹ is chlorine, (L)ₙ is 6-chloro, R³ is methyl, R⁴ is hydrogen and the combination of R¹ and R² for a compound corresponds in each case to one row of table A.

Table 155

Compounds of the formulae I.Ba, I.Bb and I.Bc, in which X is methyl, L¹ is chlorine, (L)ₙ is 6-chloro, R³ is methyl, R⁴ is hydrogen and the combination of R¹ and R² for a compound corresponds in each case to one row of table A.

Table 156

Compounds of the formulae I.Ba, I.Bb and I.Bc, in which X is methoxy, L¹ is chlorine, (L)ₙ is 6-chloro, R³ is methyl, R⁴ is hydrogen and the combination of R¹ and R² for a compound corresponds in each case to one row of table A.

Table 157

Compounds of the formulae I.Ba, I.Bb and I.Bc, in which X is chlorine, L¹ is fluorine, (L)ₙ is 6-fluoro, R³ is methyl, R⁴ is hydrogen and the combination of R¹ and R² for a compound corresponds in each case to one row of table A.

Table 158

Compounds of the formulae I.Ba, I.Bb and I.Bc, in which X is cyano, L¹ is fluorine, (L)ₙ is 6-fluoro, R³ is methyl, R⁴ is hydrogen and the combination of R¹ and R² for a compound corresponds in each case to one row of table A.

Table 159

Compounds of the formulae I.Ba, I.Bb and I.Bc, in which X is methyl, L¹ is fluorine, (L)ₙ is 6-fluoro, R³ is methyl, R⁴ is hydrogen and the combination of R¹ and R² for a compound corresponds in each case to one row of table A.

Table 160

Compounds of the formulae I.Ba, I.Bb and I.Bc, in which X is methoxy, L¹ is fluorine, (L)ₙ is 6-fluoro, R³ is methyl, R⁴ is hydrogen and the combination of R¹ and R² for a compound corresponds in each case to one row of table A.

Table 161

Compounds of the formulae I.Ba, I.Bb, I.Bc and I.Bd, in which X is chlorine, L¹ is chlorine n=0, R³ is isopropyl, R⁴ is hydrogen and the combination of R¹ and R² for a compound corresponds in each case to one row of table A.

Table 162

Compounds of the formulae I.Ba, I.Bb, I.Bc and I.Bd, in which X is cyano, L¹ is chlorine, n=0, R³ is isopropyl, R⁴ is hydrogen and the combination of R¹ and R² for a compound corresponds in each case to one row of table A.

Table 163

Compounds of the formulae I.Ba, I.Bb, I.Bc and I.Bd, in which X is methyl, L¹ is chlorine, n=0, R³ is isopropyl, R⁴ is hydrogen and the combination of R¹ and R² for a compound corresponds in each case to one row of table A.

Table 164

Compounds of the formulae I.Ba, I.Bb, I.Bc and I.Bd, in which X is methoxy, L¹ is chlorine, n=0, R³ is isopropyl, R⁴ is hydrogen and the combination of R¹ and R² for a compound corresponds in each case to one row of table A.

Table 165

Compounds of the formulae I.Ba, I.Bb, I.Bc and I.Bd, in which X is chlorine, L¹ is fluorine, n=0, R³ is isopropyl, R⁴ is hydrogen and the combination of R¹ and R² for a compound corresponds in each case to one row of table A.

Table 166

Compounds of the formulae I.Ba, I.Bb, I.Bc and I.Bd, in which X is cyano, L¹ is fluorine, n=0, R³ is isopropyl, R⁴ is hydrogen and the combination of R¹ and R² for a compound corresponds in each case to one row of table A.

Table 167

Compounds of the formulae I.Ba, I.Bb, I.Bc and I.Bd, in which X is methyl, L¹ is fluorine, n=0, R³ is isopropyl, R⁴ is hydrogen and the combination of R¹ and R² for a compound corresponds in each case to one row of table A.

Table 168

Compounds of the formulae I.Ba, I.Bb, I.Bc and I.Bd, in which X is methoxy, L¹ is fluorine, n=0, R³ is isopropyl, R⁴ is hydrogen and the combination of R¹ and R² for a compound corresponds in each case to one row of table A.

Table 169

Compounds of the formulae I.Ba, I.Bb and I.Bc, in which X is chlorine, L¹ is chlorine, (L)ₙ is 6-fluoro, R³ is isopropyl, R⁴ is hydrogen and the combination of R¹ and R² for a compound corresponds in each case to one row of table A.

Table 170

Compounds of the formulae I.Ba, I.Bb and I.Bc, in which X is cyano, L¹ is chlorine, (L)ₙ is 6-fluoro, R³ is isopropyl, R⁴ is hydrogen and the combination of R¹ and R² for a compound corresponds in each case to one row of table A.

Table 171

Compounds of the formulae I.Ba, I.Bb and I.Bc, in which X is methyl, L¹ is chlorine, (L)ₙ is 6-fluoro, R³ is isopropyl, R⁴ is hydrogen and the combination of R¹ and R² for a compound corresponds in each case to one row of table A.

Table 172

Compounds of the formulae I.Ba, I.Bb and I.Bc, in which X is methoxy, L¹ is chlorine, (L)ₙ is 6-fluoro, R³ is isopropyl, R⁴ is hydrogen and the combination of R¹ and R² for a compound corresponds in each case to one row of table A.

Table 173

Compounds of the formulae I.Ba, I.Bb and I.Bc, in which X is chlorine, L¹ is chlorine, (L)ₙ is 6-chloro, R³ is isopropyl, R⁴ is hydrogen and the combination of R¹ and R² for a compound corresponds in each case to one row of table A.

Table 174

Compounds of the formulae I.Ba, I.Bb and I.Bc, in which X is cyano, L¹ is chlorine, (L)ₙ is 6-chloro, R³ is isopropyl, R⁴ is hydrogen and the combination of R¹ and R² for a compound corresponds in each case to one row of table A.

Table 175

Compounds of the formulae I.Ba, I.Bb and I.Bc, in which X is methyl, L¹ is chlorine, (L)ₙ is 6-chloro, R³ is isopropyl, R⁴ is hydrogen and the combination of R¹ and R² for a compound corresponds in each case to one row of table A.

Table 176

Compounds of the formulae I.Ba, I.Bb and I.Bc, in which X is methoxy, L¹ is chlorine, (L)ₙ is 6-chloro, R³ is isopropyl, R⁴ is hydrogen and the combination of R¹ and R² for a compound corresponds in each case to one row of table A.

Table 177

Compounds of the formulae I.Ba, I.Bb and I.Bc, in which X is chlorine, L¹ is fluorine, (L)ₙ is 6-fluoro, R³ is isopropyl, R⁴ is hydrogen and the combination of R¹ and R² for a compound corresponds in each case to one row of table A.

Table 178

Compounds of the formulae I.Ba, I.Bb and I.Bc, in which X is cyano, L¹ is fluorine, (L)ₙ is 6-fluoro, R³ is isopropyl, R⁴ is hydrogen and the combination of R¹ and R² for a compound corresponds in each case to one row of table A.

Table 179

Compounds of the formulae I.Ba, I.Bb and I.Bc, in which X is methyl, L¹ is fluorine, (L)ₙ is 6-fluoro, R³ is isopropyl, R⁴ is hydrogen and the combination of R¹ and R² for a compound corresponds in each case to one row of table A.

Table 180

Verbindungen der Formeln I.Ba, I.Bb and I.Bc, in which X is methoxy, L¹ is fluorine, (L)ₙ is 6-fluoro, R³ is isopropyl, R⁴ is hydrogen and the combination of R¹ and R² for a compound corresponds in each case to one row of table A.

TABLE A

| No. | R¹ | R² |
|---|---|---|
| A-1 | H | H |
| A-2 | CH₃ | H |
| A-3 | CH₃ | CH₃ |
| A-4 | CH₂CH₃ | H |
| A-5 | CH₂CH₃ | CH₃ |
| A-6 | CH₂CH₃ | CH₂CH₃ |
| A-7 | CH₂CF₃ | H |
| A-8 | CH₂CF₃ | CH₃ |
| A-9 | CH₂CF₃ | CH₂CH₃ |
| A-10 | CH₂CCl₃ | H |
| A-11 | CH₂CCl₃ | CH₃ |
| A-12 | CH₂CCl₃ | CH₂CH₃ |
| A-13 | CH₂CH₂CH₃ | H |
| A-14 | CH₂CH₂CH₃ | CH₃ |
| A-15 | CH₂CH₂CH₃ | CH₂CH₃ |
| A-16 | CH₂CH₂CH₃ | CH₂CH₂CH₃ |
| A-17 | CH(CH₃)₂ | H |
| A-18 | CH(CH₃)₂ | CH₃ |
| A-19 | CH(CH₃)₂ | CH₂CH₃ |
| A-20 | CH₂CH₂CH₂CH₃ | H |
| A-21 | CH₂CH₂CH₂CH₃ | CH₃ |
| A-22 | CH₂CH₂CH₂CH₃ | CH₂CH₃ |
| A-23 | CH₂CH₂CH₂CH₃ | CH₂CH₂CH₃ |
| A-24 | CH₂CH₂CH₂CH₃ | CH₂CH₂CH₂CH₃ |
| A-25 | (±) CH(CH₃)—CH₂CH₃ | H |
| A-26 | (±) CH(CH₃)—CH₂CH₃ | CH₃ |
| A-27 | (±) CH(CH₃)—CH₂CH₃ | CH₂CH₃ |
| A-28 | (S) CH(CH₃)—CH₂CH₃ | H |
| A-29 | (S) CH(CH₃)—CH₂CH₃ | CH₃ |
| A-30 | (S) CH(CH₃)—CH₂CH₃ | CH₂CH₃ |
| A-31 | (R) CH(CH₃)—CH₂CH₃ | H |
| A-32 | (R) CH(CH₃)—CH₂CH₃ | CH₃ |
| A-33 | (R) CH(CH₃)—CH₂CH₃ | CH₂CH₃ |
| A-34 | (±) CH(CH₃)—CH(CH₃)₂ | H |
| A-35 | (±) CH(CH₃)—CH(CH₃)₂ | CH₃ |
| A-36 | (±) CH(CH₃)—CH(CH₃)₂ | CH₂CH₃ |
| A-37 | (S) CH(CH₃)—CH(CH₃)₂ | H |
| A-38 | (S) CH(CH₃)—CH(CH₃)₂ | CH₃ |
| A-39 | (S) CH(CH₃)—CH(CH₃)₂ | CH₂CH₃ |
| A-40 | (R) CH(CH₃)—CH(CH₃)₂ | H |
| A-41 | (R) CH(CH₃)—CH(CH₃)₂ | CH₃ |
| A-42 | (R) CH(CH₃)—CH(CH₃)₂ | CH₂CH₃ |
| A-43 | (±) CH(CH₃)—C(CH₃)₃ | H |
| A-44 | (±) CH(CH₃)—C(CH₃)₃ | CH₃ |
| A-45 | (±) CH(CH₃)—C(CH₃)₃ | CH₂CH₃ |
| A-46 | (S) CH(CH₃)—C(CH₃)₃ | H |
| A-47 | (S) CH(CH₃)—C(CH₃)₃ | CH₃ |
| A-48 | (S) CH(CH₃)—C(CH₃)₃ | CH₂CH₃ |
| A-49 | (R) CH(CH₃)—C(CH₃)₃ | H |
| A-50 | (R) CH(CH₃)—C(CH₃)₃ | CH₃ |
| A-51 | (R) CH(CH₃)—C(CH₃)₃ | CH₂CH₃ |
| A-52 | (±) CH(CH₃)—CF₃ | H |
| A-53 | (±) CH(CH₃)—CF₃ | CH₃ |
| A-54 | (±) CH(CH₃)—CF₃ | CH₂CH₃ |
| A-55 | (S) CH(CH₃)—CF₃ | H |
| A-56 | (S) CH(CH₃)—CF₃ | CH₃ |
| A-57 | (S) CH(CH₃)—CF₃ | CH₂CH₃ |
| A-58 | (R) CH(CH₃)—CF₃ | H |
| A-59 | (R) CH(CH₃)—CF₃ | CH₃ |
| A-60 | (R) CH(CH₃)—CF₃ | CH₂CH₃ |
| A-61 | (±) CH(CH₃)—CCl₃ | H |
| A-62 | (±) CH(CH₃)—CCl₃ | CH₃ |
| A-63 | (±) CH(CH₃)—CCl₃ | CH₂CH₃ |
| A-64 | (S) CH(CH₃)—CCl₃ | H |
| A-65 | (S) CH(CH₃)—CCl₃ | CH₃ |
| A-66 | (S) CH(CH₃)—CCl₃ | CH₂CH₃ |
| A-67 | (R) CH(CH₃)—CCl₃ | H |
| A-68 | (R) CH(CH₃)—CCl₃ | CH₃ |
| A-69 | (R) CH(CH₃)—CCl₃ | CH₂CH₃ |
| A-70 | CH₂CF₂CF₃ | H |
| A-71 | CH₂CF₂CF₃ | CH₃ |
| A-72 | CH₂CF₂CF₃ | CH₂CH₃ |
| A-73 | CH₂(CF₂)₂CF₃ | H |
| A-74 | CH₂(CF₂)₂CF₃ | CH₃ |
| A-75 | CH₂(CF₂)₂CF₃ | CH₂CH₃ |
| A-76 | CH₂C(CH₃)═CH₂ | H |
| A-77 | CH₂C(CH₃)═CH₂ | CH₃ |
| A-78 | CH₂C(CH₃)═CH₂ | CH₂CH₃ |
| A-79 | CH₂CH═CH₂ | H |
| A-80 | CH₂CH═CH₂ | CH₃ |
| A-81 | CH₂CH═CH₂ | CH₂CH₃ |
| A-82 | CH(CH₃)CH═CH₂ | H |
| A-83 | CH(CH₃)CH═CH₂ | CH₃ |
| A-84 | CH(CH₃)CH═CH₂ | CH₂CH₃ |
| A-85 | CH(CH₃)C(CH₃)═CH₂ | H |
| A-86 | CH(CH₃)C(CH₃)═CH₂ | CH₃ |
| A-87 | CH(CH₃)C(CH₃)═CH₂ | CH₂CH₃ |
| A-88 | CH₂—C≡CH | H |
| A-89 | CH₂—C≡CH | CH₃ |
| A-90 | CH₂—C≡CH | CH₂CH₃ |
| A-91 | cyclopentyl | H |
| A-92 | cyclopentyl | CH₃ |
| A-93 | cyclopentyl | CH₂CH₃ |
| A-94 | cyclohexyl | H |
| A-95 | cyclohexyl | CH₃ |
| A-96 | cyclohexyl | CH₂CH₃ |
| A-97 | CH₂—C₆H₅ | H |
| A-98 | CH₂—C₆H₅ | CH₃ |
| A-99 | CH₂—C₆H₅ | CH₂CH₃ |

| | |
|---|---|
| A-100 | —(CH₂)₂CH═CHCH₂— |
| A-101 | —(CH₂)₂C(CH₃)═CHCH₂— |
| A-102 | —CH(CH₃)CH₂—CH═CHCH₂— |
| A-103 | —(CH₂)₂CH(CH₃)(CH₂)₂— |
| A-104 | —(CH₂)₃CHFCH₂— |
| A-105 | —(CH₂)₂CHF(CH₂)₂— |
| A-106 | —CH₂CHF(CH₂)₃— |
| A-107 | —(CH₂)₂CH(CF₃)(CH₂)₂— |
| A-108 | —(CH₂)₂O(CH₂)₂— |
| A-109 | —(CH₂)₂S(CH₂)₂— |
| A-110 | —(CH₂)₅— |
| A-111 | —(CH₂)₄— |
| A-112 | —CH₂CH═CHCH₂— |
| A-113 | —CH(CH₃)(CH₂)₃— |
| A-114 | —CH₂CH(CH₃)(CH₂)₂— |
| A-115 | —CH(CH₃)—(CH₂)₂—CH(CH₃)— |
| A-116 | —CH(CH₃)—(CH₂)₄— |
| A-117 | —CH₂—CH(CH₃)—(CH₂)₃— |
| A-118 | —(CH₂)—CH(CH₃)—CH₂—CH(CH₃)—CH₂— |
| A-119 | —CH(CH₂CH₃)—(CH₂)₄— |
| A-120 | —(CH₂)₂—CHOH—(CH₂)₂— |
| A-121 | —(CH₂)₆— |
| A-122 | —CH(CH₃)—(CH₂)₅— |
| A-123 | —(CH₂)₂—N(CH₃)—(CH₂)₂— |
| A-124 | —N═CH—CH═CH— |
| A-125 | —N═C(CH₃)—CH═C(CH₃)— |
| A-126 | —N═C(CF₃)—CH═C(CF₃)— |

Compounds I according to the invention in which L² is nitro can be obtained by different routes. Advantageously, they are prepared by reacting 5-aminotriazole of the formula II with appropriately substituted phenylmalonates of the formula III in which R is alkyl, preferably C₁-C₆-alkyl, in particular Methyl or ethyl, by the method shown in scheme 1. In scheme 1, L¹ and (L)ₙ are as defined above.

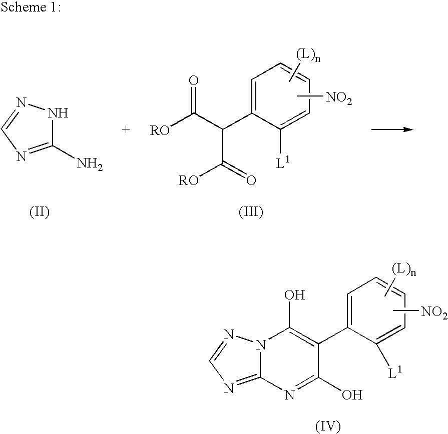

This reaction is usually carried out at temperatures of from 80° C. to 250° C., preferably from 120° C. to 180° C., without solvent or in an inert organic solvent in the presence of a base [cf. EP-A 770 615] or in the presence of acetic acid under the conditions known from Adv. Het. Chem. 57 (1993), 81 ff.

Suitable solvents are aliphatic hydrocarbons, aromatic hydrocarbons, such as toluene, o-, m- and p-xylene, halogenated hydrocarbons, ethers, nitriles, ketones, alcohols, and also N-methylpyrrolidone, dimethyl sulfoxide, dimethylformamide and dimethylacetamide. Particularly preferably, the reaction is carried out without solvent or in chlorobenzene, xylene, dimethyl sulfoxide, N-methylpyrrolidone. It is also possible to use mixtures of the solvents mentioned. If appropriate, catalytic amounts of acids, such as p-toluenesulfonic acid, acetic aid or propionic acid, may also be added.

Suitable bases are, in general, inorganic compounds, such as alkali metal and alkaline earth metal hydroxides, alkali metal and alkaline earth metal oxides, alkali metal and alkaline earth metal hydrides, alkali metal amides, alkali metal and alkaline earth metal carbonates and also alkali metal bicarbonates, organometallic compounds, in particular alkali metal alkyls, alkylmagnesium halides, and also alkali metal and alkaline earth metal alkoxides and dimethoxymagnesium, moreover organic bases, for example tertiary amines, such as trimethylamine, triethylamine, diisopropylethylamine, tributylamine and N-methylpiperidine, N-methylmorpholine, pyridine, substituted pyridines, such as collidine, lutidine and 4-dimethylaminopyridine, and also bicyclic amines. Particular preference is given to tertiary amines, such as diisopropylethylamine, tributylamine, N-methylmorpholine or N-methylpiperidine.

The bases are generally employed in catalytic amounts; however, they can also be employed in equimolar amounts, in excess or, if appropriate, as solvents.

The starting materials are generally reacted with one another in equimolar amounts. In terms of yield, it may be advantageous to employ an excess of base and malonate III, based on the triazole.

Phenylmalonates of the formula III are advantageously obtained by reacting appropriately substituted bromobenzenes with dialkyl malonates under Cu(I) catalysis [cf. Chemistry Letters, (1981), 367-370; EP-A 10 02 788].

The dihydroxytriazolopyrimidines of the formula IV are converted under the conditions known from WO-A 94/20501 into the dihalogenpyrimidines of the formula V in which Hal is a halogen atom, preferably a bromine or a chlorine atom, in particular a chlorine atom (see Scheme 2, L¹ and (L)ₙ are as defined above). Advantageous halogenating agents [HAL] are chlorinating agents or brominating agents, such as phosphorus oxybromide or phosphorus oxychloride, if appropriate in the presence of a solvent.

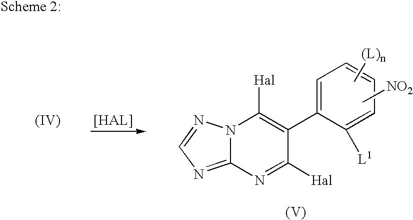

This reaction is usually carried out at from 0° C. to 150° C., preferably from 80° C. to 125° C. [cf. EP-A 770 615].

Dihalogenpyrimidines of the formula V are reacted further with amines of the formula VI to give compounds of the formula I in which X is halogen, as shown in scheme 3.

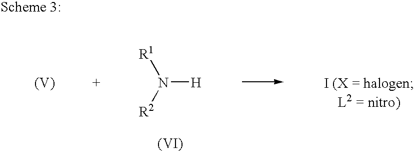

In scheme 3, R¹ and R² are as defined above.

This reaction is advantageously carried out at from 0° C. to 70° C., preferably from 10° C. to 35° C., preferably in the presence of an inert solvent, such as an ether, for example dioxane, diethyl ether or, in particular, tetrahydrofuran, a halogenated hydrocarbon, such as dichloromethane, or an aromatic hydrocarbon, such as, for example toluene [cf. WO-A 98/46608].

The use of a base, such as tertiary amine, for example triethylamine, or an inorganic amine, such as potassium carbonate, is preferred; it is also possible for excess amine of the formula VI to serve as base.

Compounds of the formula I where L²=nitro and in which X is cyano, C₁-C₄-alkoxy or C₁-C₂-haloalkoxy can be obtained advantageously by the method shown in scheme 4 from the reaction of compounds I, in which X is halogen, preferably chlorine, with compounds M-X′ (formula VII). Depending on the meaning of the group X′ to be introduced, the compounds VII are inorganic cyanides, alkoxides or haloalkoxides. The reaction is advantageously carried out in the presence of an inert solvent. The cation M in formula VII is of little importance; for practical reasons, ammonium, tetraalkyl-ammonium or alkali metal or alkaline earth metal salts are usually preferred.

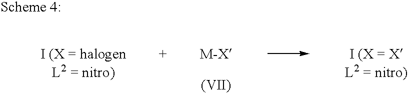

The reaction temperature is usually from 0 to 120° C., preferably from 10 to 40° C. [cf. J. Heterocycl. Chem., 12, (1975), 861-863].

Suitable solvents include ethers, such as dioxane, diethyl ether and, preferably, tetrahydrofuran, halogenated hydrocarbons such as dichloromethane, and aromatic hydrocarbons, such as toluene.

Compounds of the formula I where L²=nitro and in which X is C₁-C₄-alkyl or C₁-C₄-haloalkyl can be obtained advantageously by the synthesis route below, shown in scheme 5:

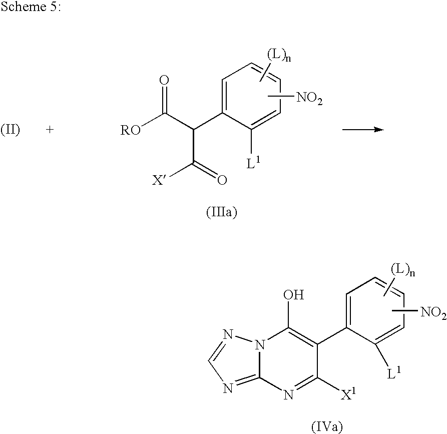

In scheme 5, R, L¹ and (L)ₙ are as defined above. The 5-alkyl-7-hydroxy-6-phenyltriazolopyrimidines IVa are obtained from the keto esters IIIa. In the formulae IIIa and IVa, X¹ is C₁-C₄-alkyl or C₁-C₄-haloalkyl. Using the easily accessible 2-phenylacetoacetic esters (IIIa where X¹═CH₃), the 5-methyl-7-hydroxy-phenyltriazolopyrimidines are obtained [cf. Chem. Pharm. Bull., 9 (1961), 801]. The starting materials IIIa are advantageously prepared under the conditions described in EP-A 10 02 788.

The 5-alkyl-7-hydroxy-6-phenyltriazolopyrimidines thus obtained are reacted with halogenating agents [HAL] under the conditions described further above to give the 7-halotriazolopyrimidines of the formula Va, as shown in scheme 6. Preference is given to using chlorinating or brominating agents, such as phosphorus oxybromide, phosphorus oxychloride, thionyl chloride, thionyl bromide or sulphuryl chloride. The reaction can be carried out neat or in the presence of a solvent. Customarily reaction temperatures are from 0 to 150° C. or, preferably from 80 to 125° C.

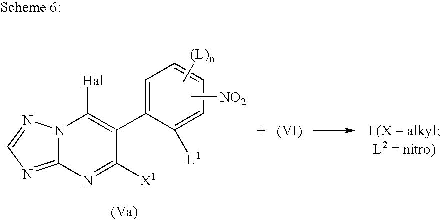

The reaction of Va with amines VI is carried out under the conditions described further above. In scheme 6, X¹, Hal, (L)ₙ and L¹ are as defined above.

Alternatively, compounds of formula I in which L² is nitro and X is C₁-C₄-alkyl can also be prepared from compounds I in which X is halogen, in particular chlorine, and malonates of the formula VIII, according to the method shown in scheme 7. In formula VIII, X″ is hydrogen or C₁-C₃-alkyl and R is C₁-C₄-alkyl. They are converted into compounds of the formula IX and decarboxylated to give the compounds I [cf. U.S. Pat. No. 5,994,360].

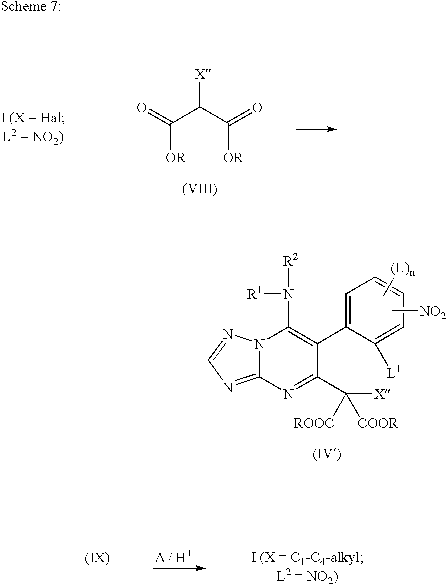

In scheme 7, (L)ₙ and L¹ are as defined above. The malonates VII are known from the literature [J. Am. Chem. Soc., 64 (1942), 2714; J. Org. Chem., 39 (1974), 2172; Helv. Chim. Acta, 61 (1978), 1565], or they can be prepared in accordance with the literature cited.

The subsequent hydrolysis of the ester IX is carried out under generally customary conditions; depending on the different structural elements, alkali or acidic hydrolysis of the compounds IX or ester cleavage in the presence of lithium salts (Greene & Wuts, Protective Groups in Organic Synthesis, Wiley 1991, p. 232 ff) may be advantageous. Under the conditions of ester hydrolysis, there may already be complete or partial decarboxylation to I.

The decarboxylation is usually carried out at temperatures of from 20° C. to 180° C., preferably from 50° C. to 120° C., in an inert solvent, if appropriate in the presence of an acid.

Suitable acids are hydrochloric acid, sulfuric acid, phosphoric acid, formic acid, acetic acid, p-toluenesulfonic acid. Suitable solvents are water, aliphatic hydrocarbons, such as pentane, hexane, cyclohexane and petroleum ether, aromatic hydrocarbons, such as toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran, nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethylsulfoxide, dimethylformamide and dimethylacetamide; with particular preference, the reaction is carried out in hydrochloric acid or acetic acid. It is also possible to use mixtures of the solvents mentioned.

Compounds of the formula I in which L² is nitro and X is C₁-C₄-alkyl can also be obtained by coupling 5-halotriazolopyrimidines of the formula I in which L² is nitro and X is halogen with organometallic reagents of the formula X (see scheme 8). In one embodiment of this process, the reaction is carried out with transition metal catalysis, such as Ni or Pd catalysis.

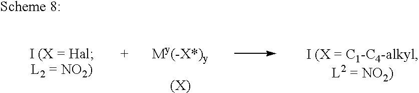

In formula X, M is a metal ion of the valency y, such as, for example, B, Zn or Sn, and X* is C₁-C₄-alkyl. This reaction can be carried out, for example, analogously to the following methods: J. Chem. Soc. Perkin Trans. 1 (1994), 1187, ibid. 1 (1996), 2345; WO-A 99/41255; Aust. J. Chem., 43 (1990), 733; J. Org. Chem., 43 (1978), 358; J. Chem. Soc. Chem. Commun. (1979), 866; Tetrahedron Lett., 34 (1993) 8267; ibid. 33, (1992), 413.

The compounds of the formula I according to the invention in which L² is nitro can also be obtained by nitration of the compounds of the formula XI, as shown in scheme 9.

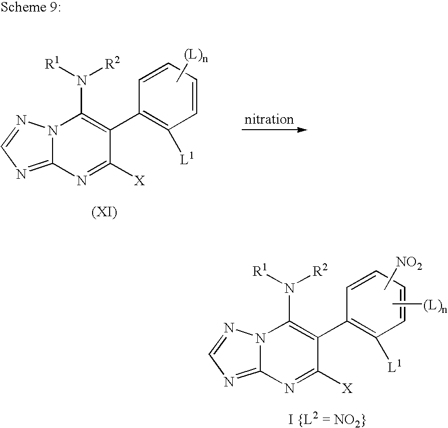

In Scheme 9, R¹, R², X, L¹ and (L)ₙ are as defined above. Suitable nitrating agents are, for example, different concentrations of nitric acid including concentrated and fuming nitric acid, mixtures of sulfuric acid and nitric acid, moreover acetyl nitrates and alkyl nitrates.

The reaction can either be carried out in the absence of a solvent in an excess of nitrating agent, or in an inert solvent or diluent, suitable solvents or diluents being, for example, water, mineral acids, organic acids, halogenated hydrocarbons, such as methylene chloride, anhydrides, such as acetic anhydride, and mixtures of these solvents.

The starting material XI and the nitrating agent are expediently employed in approximately equimolar amounts; however, for optimum conversion of starting material it may be advantageous to use an excess of nitrating agent of up to about 10 times the molar amount, based on the starting material VIII. If the reaction is carried out without solvent in the nitrating agent, this is present in an even higher excess.

The reaction temperature is usually from −100° C. to 200° C., preferably from −30 to 50° C.

The starting materials XI are known, for example, from WO 03/080615, WO 03/008417 or WO 02,46195, or they can be prepared analogously to the process as described therein.

The compounds of the formula I according to the invention in which L² is C(S)NR³R⁴ can also be obtained by different routes, for example starting with cyanophenyltriazolopyrimidines XII according to the method shown in scheme 10 by reaction with hydrogen sulfide gas.

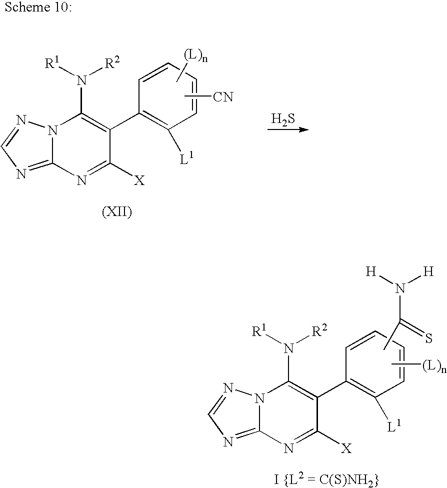

In scheme 10, L¹, (L)ₙ, R¹, R² and X are as defined above. In general, the reaction is carried out in the presence of a solvent or diluent. Suitable solvents or diluents are, for example, aromatic amines, such as pyridine, substituted pyridines, such as collidine and lutidine, or tertiary amines, such as trimethylamine, triethylamine, triisopropylamine and N-methylpiperidine.

The reaction between the cyanophenyltriazolopyrimidines XII and hydrogen sulfide is advantageously carried out at from 0° C. to 100° C., in particular from 10° C. to 50° C.

The cyanophenyltriazolopyrimidines XII are known from WO 03/080615 or can be prepared in accordance with the literature cited therein.

The aminothiocarbonylphenyltriazolopyrimidines I{L²=—C(S)NH₂} obtained in this manner can then, if appropriate, be mono- or dialkylated at the amine nitrogen atom in a subsequent step by reaction with an alkylating agent. Suitable alkylating agents are, for example, C₁-C₆-alkyl halides, di-C₁-C₆-alkyl sulfates or C₁-C₆-alkyl phenylsulfonates, where the phenyl radical may, if appropriate, carry one or two radicals selected from the group consisting of nitro and C₁-C₆-alkyl. In general, an at least equimolar amount of alkylating agent, based on the thioamide I, is employed. The alkylation is usually carried out in the presence of a base. Suitable bases are, in principle, all compounds capable of deprotonating the amide nitrogen. Suitable bases are, for example, alkali metal and alkaline earth metal hydroxides, such as sodium hydroxide, potassium hydroxide, lithium hydroxide and magnesium hydroxide, alkali metal and alkaline earth metal oxides, such as calcium oxide, alkali metal or alkaline earth metal carbonates, such as lithium carbonate, sodium carbonate, potassium carbonate, magnesium carbonate, calcium carbonate. Based on the thioamide I, the base may be employed in a substoichiometric, superstoichiometric or equimolar amount.

Alternatively, the compounds of the formula I according to the invention in which L² is C(S)NR³R⁴ can be prepared by reacting carboxamide compounds XIII with a sulfurizing agent, by the method shown in scheme 11.

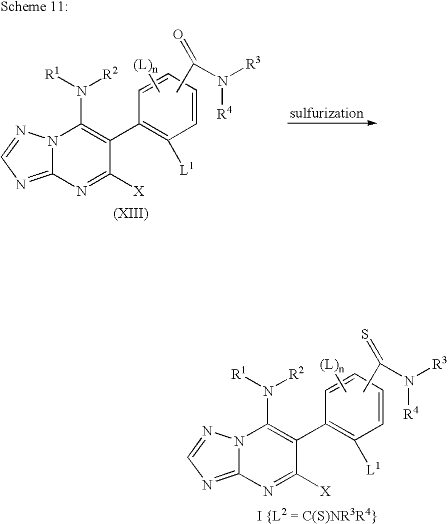

In Scheme 11, R¹, R², R³, R⁴, (L)ₙ and X are as defined above. Examples of suitable sulfurizing agents are organophosphorus sulfides, such as Lawesson's reagent (2,2-bis(4-methoxyphenyl)-1,3,2,4-dithiadiphosphetane 2,4-disulfide), organotin sulfides, such as bis(tricyclohexyltin)sulfide or phosphorus pentasulfide (see also J. March, Advanced Organic Synthesis, 4th edition, Wiley Interscience 1992, p. 893 f and the literature cited therein). The reaction can be carried out in a solvent or neat. Suitable solvents are the inert organic solvents mentioned above, and also pyridine and the like. The temperature required for the reaction is generally above room temperature and in particular in the range of from 50 to 200° C.

The starting materials XII are known from WO 03/080615 or can be prepared analogously to the processes described therein.

The preparation of compounds of the formula I in which L² is a group —C(═N—OR⁵)(NR⁶R⁷) can be achieved, for example, by reacting compounds of the formula I in which L² is —C(S)NR³R⁴ with hydroxylamine hydrochloride, followed, if appropriate, by an alkylation. Here, R³ and R⁴ have the same meaning as R⁶ and R⁷. With respect to suitable alkylating agents, solvents and bases, reference is made to what was said above in its entirety.

Alternatively, compounds of the formula I in which L² is a group —C(═N—OH)(NH₂) can be prepared by the route shown in Scheme 12.

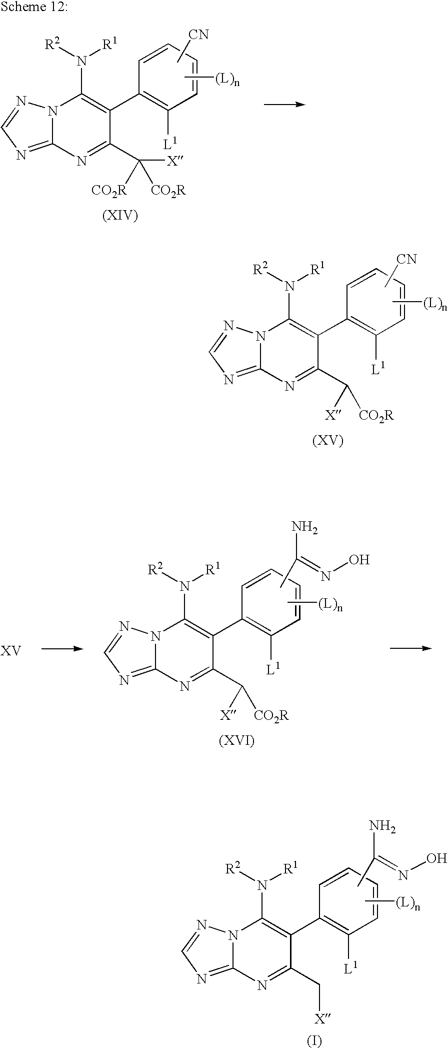

In Scheme 12, (L)ₙ, R¹ and R² are as defined above. L¹ is halogen, in particular chlorine. R is C₁-C₄-alkyl and X″ is hydrogen or C₀-C₃-alkyl. The partial hydrolysis and subsequent decarboxylation of XIV to give XV is carried out under generally customary conditions; depending on the various structural elements, alkaline or acidic hydrolysis of the compound XIV or ester cleavage in the presence of lithium salts may be advantageous. Under the conditions of ester hydrolysis, there may already be complete or partial decarboxylation to XV.

The decarboxylation is generally carried out in an inert solvent, at temperatures of from 20° C. to the boiling point of the solvents. With respect to suitable solvents, reference is made to the solvents which can be used for decarboxylating the compound IX to give I.

The compound XV is then reacted with hydroxylamine hydrochloride, which gives the compound XVI. In general, the reaction is carried out in a solvent. Suitable solvents are alkanols, in particular C₁-C₄-alkanols, for example methanol. The conversion of XV to XVI is usually carried out in the presence of a base. Suitable bases are, for example, alkali metal and alkaline earth metal hydroxides, such as sodium hydroxide, potassium hydroxide, lithium hydroxide and magnesium hydroxide, alkali metal and alkaline earth metal oxides, such as calcium oxide, alkali metal or alkaline earth metal carbonates, such as lithium carbonate, sodium carbonate, potassium carbonate, magnesium carbonate, calcium carbonate. The base is generally employed in a substoichiometric amount, in a stoichiometric amount or in excess, based on the hydroxylamine hydrochloride.

The subsequent hydrolysis of the compound XVI and decarboxylation affords the desired compound I. With respect to the hydrolysis and decarboxylation of the compound XVI to the compound I, reference is made to everything stated above concerning the conversion of the compound IX into I.

Compounds of the formula I, in which L² is a group —C(═N—OR⁵)(NR⁶R⁷) can be prepared from compounds I, in which L² is a group —C(═N—H)(NH₂) by alkylation. With respect to suitable alkylating agents, solvents and bases, reference is made to everything stated above.

Compounds of the formula XIV are known, for example, from U.S. Pat. No. 5,994,360, EP 550113, WO 94/20501, EP 770615 or WO 98/4149, or they can be prepared analogously to the processes mentioned in these publications.

The preparation of compounds of the formula I in which L² is a group —C(═N—NR⁸R⁹)(NR¹⁰R¹¹) can be achieved, for example, by reacting compounds of the formula I in which X is —C(S)NR³R⁴ with substituted hydrazine derivatives in acidic solvent. Here, R³ and R⁴ have the same meaning as R¹⁰ and R¹¹.

Compounds of the formula I in which L² is a group —C(═N—OR⁵)(NH₂) or —C(═N—NR⁸R⁹)—NH₂ can advantageously also be prepared from the nitrile XII using the methods shown in scheme 13. Here, the nitrile XII can firstly be reacted directly with NH₂OR⁵ (where R⁵ is as defined above) or salts thereof in aqueous solution, preferably in water or water/alkanol mixtures, if appropriate in the presence of base, to give the compound I where L²=—C(═N—OR⁵)(NH₂), or with H₂N—NR⁸R⁹ (in which R⁸ and R⁹ are as defined above) to give the compound I where L²=—C(═N—NR⁸R⁹)—NH₂. This reaction can be carried out, for example, analogously to the following methods: WO 00/17156, WO 00/24740, U.S. Pat. No. 5,104,991, U.S. Pat. No. 4,379,158, Journal of Organic Chemistry, 58 (16), (1993), 4331; Acta Pol. Pharm. 36 (1979), 155. Compounds of the formula I in which L² is a group —C(═N—OR⁵)(NH₂) or a group —C(═N—NR⁸R⁹)—NH₂ can secondly also be prepared by reacting the nitrile XII with an alchol R¹³—OH, such as a C₁-C₄-alkanol, and hydrogen chloride in the absence of water to give an imidocarboxylic ester XVII, followed by reaction of the imidocarboxylic ester XVII obtained with NH₂OR⁵ or H₂N—NR⁸R⁹ (in which R⁵, R⁸ and R⁹ are as defined above). The imidocarboxylic ester XVII can be prepared, for example, analogously to the conditions known from Jerry March, 3rd edition, John Wiley & Sons, New York, 1985, p. 792.

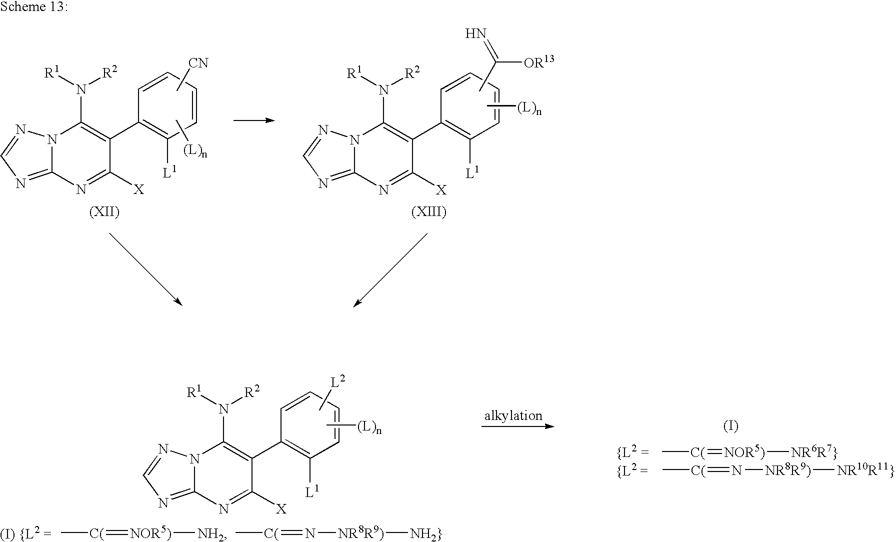

In Scheme 13, R¹, R², X, (L)ₙ and L¹ are as defined above; R¹³ is, for example C₁-C₄-alkyl. The resulting compounds I in which L² is a group —C(═N—OR⁵)(NH₂) or —C(═N—NR⁸R⁹)—NH₂ can be alkylated in a known manner giving compounds I in which L² is —C(═N—OR⁵)(NR⁶R⁷) or —C(═N—NR⁸R⁹)(NR¹⁰R¹¹), where R⁵, R⁶, R⁷, R⁸, R⁹, R¹⁰ and R¹¹ are as defined above. With respect to suitable processes for the alkylation, reference is made to what was said above in its entirety.

The reaction mixtures are worked up in a customary manner, for example by mixing with water, separating the phases and, Hf appropriate, chromatographic purification of the crude products. Some of the intermediates and end products obtained in the form of colorless or slightly brownish viscous oils which are purified or freed from volatile components under reduced pressure and at moderately elevated temperature. If the intermediates and end products are obtained as solids, purification can also be carried out by recrystallization or digestion.

If individual compounds I cannot be obtained by the routes described above, they can be prepared by derivatization of other compounds I.

If the synthesis yields mixtures of isomers, a separation is generally not necessarily required however since in some cases the individual isomers can be interconverted during work-up for use or during use (for example under the action of light, acids or bases). Such conversions may also take place after use, for example in the treatment of plants in the treated plant, or in the harmful fungus or animal pest to be controlled.

The compounds I are suitable as fungicides. They are distinguished by an outstanding effectiveness against a broad spectrum of phytopathogenic fungi, especially from the classes of the Ascomycetes, Deuteromycetes, Oomycetes and Basidiomycetes. Some are systemically effective and they can be used in plant protection as foliar and soil fungicides.

They are particularly important in the control of a multitude of fungi on various cultivated plants, such as wheat, rye, barley, oats, rice, maize, grass, bananas, cotton, soya, coffee, sugar cane, vines, fruits and ornamental plants, and vegetables, such as cucumbers, beans, tomatoes, potatoes and cucurbits, and on the seeds of these plants.

They are especially suitable for controlling the following plant diseases:
Alternaria species on fruit and vegetables,
Bipolaris and Drechslera species on cereals, rice and lawns,
Blumeria graminis (powdery mildew) on cereals,
Botrytis cinerea (gray mold) on strawberries, vegetables, ornamental plants and grapevines,
Erysiphe cichoracearum and Sphaerotheca fuliginea on cucurbits,
Fusarium and Verticillium species on various plants,
Mycosphaerella species on cereals, bananas and peanuts,
Phytophthora infestans on potatoes and tomatoes,
Plasmopara viticola on grapevines,
Podosphaera leucotricha on apples,
Pseudocercosporella herpotrichoides on wheat and barley,
Pseudoperonospora species on hops and cucumbers,
Puccinia species on cereals,
Pyricularia oryzae on rice,
Rhizoctonia species on cotton, rice and lawns,
Septoria tritici and Stagonospora nodorum on wheat,
Uncinula necator on grapevines,
Ustilago species on cereals and sugar cane, and
Venturia species (scab) on apples and pears.

The compounds I are also suitable for controlling harmful fungi, such as Paecilomyces variotii, in the protection of materials (e.g. wood, paper, paint dispersions, fibers or fabrics) and in the protection of stored products.

The compounds I are employed by treating the fungi or the plants, seeds, materials or soil to be protected from fungal attack with a fungicidally effective amount of the active compounds. The application can be carried out both before and after the infection of the materials, plants or seeds by the fungi.

The fungicidal compositions generally comprise between 0.1 and 95%, preferably between 0.5 and 90%, by weight of active compound.

When employed in plant protection, the amounts applied are, depending on the kind of effect desired, between 0.01 and 2.0 kg of active compound per ha.

In seed treatment, amounts of active compound of 1 to 1000 g/100 kg of seed, preferably 1 to 200 g/100 kg, in particular 5 to 100 g/100 kg are generally used.

When used in the protection of materials or stored products, the amount of active compound applied depends on the kind of application area and on the effect desired. Amounts customarily applied in the protection of materials are, for example, 0.001 g to 2 kg, preferably 0.005 g to 1 kg, of active compound per cubic meter of treated material.

The compounds I can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable are essentially.
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propano, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound. The active compounds are employed in a purity of from 90% to 100%, preferably 95% to 100% (according to NMR spectrum).

The following are examples of formulations:

1. Products for dilution with water

A Water-soluble concentrates (SL)

10 parts by weight of a compound according to the invention are dissolved in water or in a water-soluble solvent. As an alternative, wetters or other auxiliaries are added. The active compound dissolves upon dilution with water.

B Dispersible concentrates (DC)

20 parts by weight of a compound according to the invention are dissolved in cyclohexanone with addition of a dispersant, for example polyvinylpyrrolidone. Dilution with water gives a dispersion.

C Emulsifiable concentrates (EC)

15 parts by weight of a compound according to the invention are dissolved in xylene with addition of calcium dodecylbenzenesulfonate and castor oil ethoxylate (in each case 5%). Dilution with water gives an emulsion.

D Emulsions (EW, EO)

40 parts by weight of a compound according to the invention are dissolved in xylene with addition of calcium dodecylbenzenesulfonate and castor oil ethoxylate (in each case 5%). This mixture is introduced into water by means of an emulsifying machine (Ultraturrax) and made into a homogeneous emulsion. Dilution with water gives an emulsion.

E Suspensions (SC, OD)

In an agitated ball mill, 20 parts by weight of a compound according to the invention are comminuted with addition of dispersants, wetters and water or an organic solvent to give a fine active compound suspension. Dilution with water gives a stable suspension of the active compound.

F Water-dispersible granules and water-soluble granules (WG, SG)

50 parts by weight of a compound according to the invention are ground finely with addition of dispersants and wetters and made into water-dispersible or water-soluble granules by means of technical appliances (for example extrusion, spray tower, fluidized bed). Dilution with water gives a stable dispersion or solution of the active compound.

G Water-dispersible powders and water-soluble powders (WP, SP)

75 parts by weight of a compound according to the invention are ground in a rotor-stator mill with addition of dispersants, wetters and silica gel. Dilution with water gives a stable dispersion or solution of the active compound.

2. Products to be applied undiluted

H Dustable powders (DP)

5 parts by weight of a compound according to the invention are ground finely and mixed intimately with 95% of finely divided kaolin. This gives a dustable product.

I Granules (GR, FG, GG, MG)

0.5 part by weight of a compound according to the invention is ground finely and associated with 95.5% carriers. Current methods are extrusion, spray-drying or the fluidized bed. This gives granules to be applied undiluted.

J ULV solutions (UL)

10 parts by weight of a compound according to the invention are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended uses; the intention is to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), by which it is possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate not until immediately prior to use (tank mix). These agents can be admixed with the agents according to the invention in a weight ratio of 1:10 to 10:1.

The compositions according to the invention can, in the use form as fungicides, also be present together with other active compounds, e.g. with herbicides, insecticides, growth regulators, fungicides or else with fertilizers. Mixing the compounds I or the compositions comprising them in the application form as fungicides with other fungicides results in many cases in an expansion of the fungicidal spectrum of activity being obtained.

The following list of fungicides, in conjunction with which the compounds according to the invention can be used, is intended to illustrate the possible combinations but does not limit them:
acylalanines, such as benalaxyl, metalaxyl, ofurace or oxadixyl,
amine derivatives, such as aldimorph, dodine, dodemorph, fenpropimorph, fenpropidin, guazatine, iminoctadine, spiroxamine or tridemorph,
anilinopyrimidines, such as pyrimethanil, mepanipyrim or cyprodinyl,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, epoxiconazole, fenbuconazole, fluquinconazole, flusilazole, flutriatol, hexaconazole, imazalil, metconazole, myclobutanil, penconazole, propiconazole, prochloraz, prothioconazole, tebuconazole, triadimefon, triadimenol, triflumizole or triticonazole,
dicarboximides, such as iprodione, myclozolin, procymidone or vinclozolin,
dithiocarbamates, such as ferbam, nabam, maneb, mancozeb, metam, metiram, propineb, polycarbamate, thiram, ziram or zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole or triforine,
copper fungicides, such as Bordeaux mixture, copper acetate, copper oxychloride or basic copper sulfate,
nitrophenyl derivatives, such as binapacryl, dinocap, dinobuton or nitrophthal-isopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene or zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet or tolylfluanid,
cinnamides and analogous compounds, such as dimethomorph, flumetover or flumorph.

### SYNTHESIS EXAMPLES

### Example 1

### Preparation of 5-chloro-6-(2,6-difluoro-4-aminothiocarbonylphenyl)-7-(4-methylpiperidin-1-yl)-[1,2,4]-triazolo[1,5-a]pyrimidine

At room temperature, hydrogen sulfide gas was passed through a mixture of 10 g (25.7 mmol) of 5-chloro-6-(2,6-difluor-4-cyanophenyl)-7-(4-methylpiperidin-1-yl)-[1,2,4]-triazolo[1,5-a]pyrimidine [prepared as described in WO 03/080615], 12 ml of triethylamine and 120 ml of pyridine. This resulted in an increase of the temperature of the reaction mixture. By cooling with an ice-water bath, the reaction temperature was kept between 20° C. and 30° C.

After 30 minutes, it was no longer possible to detect starting material by thin-layer chromatography. The reaction flask was flushed with nitrogen, and the reaction mixture was poured into a mixture of diluted sulfuric acid and ice (pH: 2-3). The aqueous reaction mixture was extracted three times with methyl tert-butyl ether. The combined organic phases were washed with dilute hydrochloric acid and water and dried over magnesium sulfate, and the drying agent was then filtered off. The filtrate obtained was concentrated under reduced pressure. The residue crystallized and was titrated with methylene chloride. This gave 9.8 g of the title compound (purity about 80%, yield about 72%) as light-yellow crystals of melting point 242° C. (decomposition).

¹H-NMR (DMSO-d₆) δ: 10.3 (s, 1H), 9.8 (s, 1H), 8.65 (s, 1H), 7.8 (d, 2H), 3.65 (d, 2H), 2.85 (t, 2H), 1.6 (m, 3H), 1.2 (m, 2H), 0.9 (d, 3H).

### Example 56

### Preparation of 5-chloro-6-(2-chloro-5-nitrophenyl)-7-(4-methylpiperidin-1-yl)-[1,2,4]-triazolo[1,5-a]pyrimidine

A mixture of 0.24 g (0.7 mmol) of 5,7-dichloro-6-(2-chloro-5-nitrophenyl)-[1,2,4]-triazolo[1,5-a]pyrimidine and 1.0 g (1.05 mmol) of 4-methylpiperidine in 4 ml of methylene chloride was stirred at 35° C. for 5 hours and at room temperature for 15 hours. The reaction mixture was then extracted twice with 1 M hydrochloric acid and with sodium chloride solution, and the organic phase was dried over magnesium sulfate and concentrated. The residue obtained was 0.24 g (84% of theory) of the title compound as a colorless solid having a melting point of from 199 to 204° C.

HPLC/MS: Rt=3.58 min; m/e=407 (M+H)

HPLC column: RP-18 column (Chromolith Speed ROD from Merck KgaA, Germany)

Mobile phase: acetonitrile+0.1% trifiuoroacetic acid (TFA)/water+0.1% TFA in a gradient of from 5:95 to 95:5 over 5 minutes at 40° C.

MS: Quadrupol Electrospray Ionization, 80 V (positive mode)

The compounds of the formula I listed in table 1 below were prepared in an analogous manner.

TABLE 1

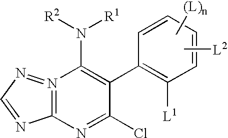

| | | | | | | m.p. [° C]/ |
|---|---|---|---|---|---|---|
| Ex. | R¹ | R² | L¹ | L² | (L)ₙ | consistency |
| 1. | (CH₂)₂—CH(CH₃)—(CH₂)₂ | H | F | 4-C(═S)NH₂ | 6-F | 242 |
| | | | | | | (decomp.) |
| 2. | cyclopentyl | H | F | 5-NO₂ | — | yellow resin |
| 3. | CH(CH₃)₂ | H | F | 5-NO₂ | — | 167 |
| 4. | C₂H₅ | C₂H₅ | F | 5-NO₂ | — | 185-187 |
| 5. | (CH₂)₆ | | F | 5-NO₂ | — | 208-212 |
| 6. | cyclopentyl | H | Cl | 5-NO₂ | | yellow resin |
| 7. | CH(CH₃)₂ | H | Cl | 5-NO₂ | — | yellow resin |
| 8. | C₂H₅ | C₂H₅ | Cl | 5-NO₂ | — | 189 |
| 9. | (CH₂)₆ | | Cl | 5-NO₂ | — | 172-177 |
| 10. | (CH₂)₅ | | Cl | 5-NO₂ | — | 185-187 |
| 11. | (CH₂)₂—CH(CH₃)—(CH₂)₂ | | Cl | 3-NO₂ | 6-F | yellow resin |
| 12. | H₂C═C(CH₃)—CH₂ | C₂H₅ | F | 4-NO₂ | — | 170 |
| 13. | (CH₂)₂—CH(CH₃)—(CH₂)₂ | | Cl | 4-NO₂ | — | 203-205 |
| 14. | H₂C═C (CH₃)—CH₂ | C₂H₅ | Cl | 4-NO₂ | — | 165-167 |
| 15. | CH(CH₃)₂ | H | F | 4-NO₂ | — | 169-170 |
| 16. | cyclopentyl | H | F | 4-NO₂ | — | 200-201 |
| 17. | CF₂—CH₂ | H | F | 4-NO₂ | — | 237 |
| 18. | bicyclo[2.2.2]hept-2-yl | H | F | 4-NO₂ | — | 203 |
| 19. | (CH₂)₂—CH(CH₃)—(CH₂)₂ | | F | 4-NO₂ | — | 231 |
| 20. | (CH₃)₃C-CH(CH₃) | H | F | 4-NO₂ | — | 165 |
| 21. | (CH₃)₃C—CH₂C(CH₃)₂ | H | F | 4-NO₂ | — | 143 |
| 22. | CF₃—CH(CH₃) | H | F | 4-NO₂ | — | 241 |
| 23. | H | H | F | 4-NO₂ | — | |
| 24. | (CH₂)₂—CH(CH₃)—(CH₂)₂ | | Cl | 6-NO₂ | — | |
| 25. | (CH₂)₆ | | Cl | 6-NO₂ | — | |
| 26. | CH(CH₃)—(CH₂)₃ | | Cl | 6-NO₂ | — | |
| 27. | cyclopentyl | H | Cl | 6-NO₂ | — | |
| 28. | (CH₂)₅ | | Cl | 6-NO₂ | — | |
| 29. | (CH₂)₂—CH(CH₃)—(CH₂)₂ | | Cl | 4—C(═S)NH₂ | — | 162-165 |
| 30. | (R)—CH(CH₃)—CH(CH₃)₂ | H | Cl | 4-C(═S)NH₂ | — | atropisomer |
| | | | | | | 1: 98-102 |
| 31. | (R)—CH(CH₃)—CH(CH₃)₂ | H | Cl | 4-C(═S)NH₂ | | atropisomer |
| | | | | | | 2: 101-112 |
| 32. | (R)—CH(CH₃)—C(CH₃)₃ | H | Cl | 4-C(═S)NH₂ | — | atropisomer |
| | | | | | | 1: 102-110 |
| 33. | (R)—CH(CH₃)—C(CH₃)₃ | H | Cl | 4-C(═S)NH₂ | — | atropisomer |
| | | | | | | 2: 123-126 |
| 34. | CH_{2—CF}₃ | H | Cl | 4-C(═S)NH₂ | — | 205-208 |
| 35. | CH(CH₃)CF₃ | H | CH₃ | 4-NO₂ | — | yellow resin |
| 36. | CH₂—CF₃ | H | CH₃ | 4-NO₂ | — | yellow resin |
| 37. | (S)—CH(CH₃)_{CF}₃ | H | CH₃ | 4-NO₂ | — | 122-162 |
| 38. | CH₂—CH(CH₃)—(CH₂)₂ | | CH₃ | 4-NO₂ | — | 157-160 |
| 39. | (CH₂)_{2—CH(CH}₃)—(CH₂)₂ | | CH₃ | 4-NO₂ | — | 132-165 |
| 40. | CH₂—C(CH₃)═CH₂ | C₂H₅ | CH₃ | 4-NO₂ | — | 184-186 |
| 41. | CH(CH₃)—C(CH₃)₃ | H | CH₃ | 4-NO₂ | — | 211-213 |
| 42. | CH(CH₃)—(CH₂)₃ | | CH₃ | 4-NO₂ | — | 168-170 |
| 43. | CH(CH₃)—(CH₂)₄ | | CH₃ | 4-NO₂ | — | yellow resin |
| 44. | (R)—CH(CH₃)—C(CH₃)₃ | H | CH₃ | 4-NO₂ | — | 211-213 |
| 45. | CH(CH₃)—CH(CH₃)₂ | H | CH₃ | 4-NO₂ | — | 188-191 |
| 46. | CH(CH₃)—CH_{2—CH}₃ | H | CH₃ | 4-NO₂ | — | 193-195 |
| 47. | (R)—OH(CH₃)—CH(CH₃)₂ | H | CH₃ | 4-NO₂ | — | 160-162 |
| 48. | CH_{2—CF}₃ | CH₃ | CH₃ | 4-NO₂ | — | 150-156 |
| 49. | (CH₂)_{2—CH(CH}₃)—(CH₂)₂ | | Cl | 4-NO₂ | 5-Cl | 204-207 |
| 50. | CH(CH₃)—CH₂—CH₃ | H | Cl | 4-NO₂ | 5-Cl | 195-198 |
| 51. | CH(CH₃)—(CH₂)₃ | | Cl | 4-NO₂ | 5-Cl | yellow resin |
| 52. | CH(CH₃)—(CH₂)₄ | | Cl | 4-NO₂ | 5-Cl | 178-179 |
| 53. | CH₂—CH(CH₃)—(CH₂)₂ | | Cl | 4-NO₂ | 5-Cl | yellow resin |
| 54. | (R)—CH(CH₃)—C(CH₃)₃ | H | Cl | 4-NO₂ | 5-Cl | yellow resin |
| 55. | (R)—CH(CH₃)—CH(CH₃)₂ | H | Cl | 4-NO₂ | 5-Cl | yellow resin |
| 56. | (CH₂)₂—CH(CH₃)—(CH₂)₂ | | Cl | 5-NO₂ | — | 199-204 |
| 57. | CH₂—C(CH₃)═CH₂ | C₂H₅ | Cl | 5-NO₂ | — | 159-166 |
| 58. | CH(CH₃)—C(CH₃)₃ | H | Cl | 5-NO₂ | — | 77-90 |
| 59. | CH(CH₃)—CH₂—CH₃ | H | Cl | 5-NO₂ | — | 67-93 |
| 60. | CH(CH₃)CF₃ | H | Cl | 5-NO₂ | — | 185-197 |
| 61. | CH₂—CF₃ | H | Cl | 5-NO₂ | — | 196-207 |
| 62. | (R)—CH(CH₃)—CH(CH₃)₂ | H | Cl | 5-NO₂ | — | 118-130 |
| 63. | CH(CH₃)—(CH₂)₃ | | Cl | 5-NO₂ | — | 96-140 |
| 64. | CH(CH₃)—(CH₂)₄ | | Cl | 5-NO₂ | — | 135-136 |
| 65. | CH(CH₃)—CH(CH₃)₂ | H | Cl | 5-NO₂ | — | 132-137 |
| 66. | (R)—CH(CH₃)—C(CH₃)₃ | H | Cl | 5-NO₂ | — | 72-95 |
| 67. | (S)—CH(CH₃)CF₃ | H | Cl | 5-NO₂ | — | 124-134 |
| 68. | CH₂—CH(CH₃)—(CH₂)₂ | | CH₃ | 5-NO₂ | — | 87-115 |
| 69. | CH(CH₃)CF₃ | H | CH₃ | 5-NO₂ | — | 98-115 |
| 70. | CH₂—CF₃ | H | CH₃ | 5-NO₂ | — | yellow resin |
| 71. | (S)—CH(CH₃)CF₃ | H | CH₃ | 5-NO₂ | — | yellow resin |
| 72. | CH₂—CH(CH₃)—(CH₂)₂ | | CH₃ | 5-NO₂ | — | 124-125 |
| 73. | (CH₂)₂—CH(CH₃)—(CH₂)₂ | | CH₃ | 5-NO₂ | — | 164-190 |
| 74. | CH₂—C(CH₃)═CH₂ | C₂H₅ | CH₃ | 5-NO₂ | — | 191-198 |
| 75. | CH(CH₃)—C(CH₃)₃ | H | CH₃ | 5-NO₂ | — | 150-156 |
| 76. | CH(CH₃)—(CH₂)₃ | | CH₃ | 5-NO₂ | — | yellow resin |
| 77. | CH(CH₃)—(CH₂)₄ | | CH₃ | 5-NO₂ | — | 180 |
| 78. | (R)—CH(CH₃)—C(CH₃)₃ | H | CH₃ | 5-NO₂ | — | 160 |
| 79. | CH(CH₃)—CH(CH₃)₂ | H | CH₃ | 5-NO₂ | — | 149-152 |
| 80. | CH(CH₃)—CH₂—CH₃ | H | CH₃ | 5-NO₂ | — | 147-149 |
| 81. | (R)—CH(CH₃)—CH(CH₃)₂ | H | CH₃ | 5-NO₂ | — | yellow resin |
| 82. | CH₂—CF₃ | CH₃ | Cl | 5-NO₂ | — | 170-172 |
| 83. | CH₂—CF₃ | CH₃ | CH₃ | 5-NO₂ | — | yellow resin |

m.p.: melting point
Ex.: example

The compounds listed in Table II below were prepared in an analogous manner.

TABLE II

| | | | | | | | |
|---|---|---|---|---|---|---|---|
| Exam- | | | | | | | m.p. [° C]/ |
| ple | X | R¹ | R² | L¹ | L² | (L)ₙ | ¹H-NMR [ppm] |

| | | | | | | |
|---|---|---|---|---|---|---|
| 84 | CH₃ | (CH₂)₂—CH(CH₃)—(CH₂)₂ | Cl | 4-C(═S)NH₂ | — | CDCl₃: δ 8.45 (s, |
| | | | | | | broad, 1H); 8.35 (s, |
| | | | | | | 1H); 8.2 (s, broad, |
| | | | | | | 1H); 2.25 (s, 3H); |
| | | | | | | 0.95 (d, 3H) |
| 85 | OCH₃ | (CH₂)₂—CH(CH₃)—(CH₂)₂ | Cl | 4-C(═S)NH₂ | — | 215-217 |
| 86 | CN | (CH₂)₂—CH(CH₃)—(CH₂)₂ | Cl | 4-C(═S)NH₂ | — | CDCl₃: δ 8.5 (s, |
| | | | | | | 1H); 8.3 (s, broad, |
| | | | | | | 1H); 8.1 (s, broad, |
| | | | | | | 1H); 0.95 (d, 3H) |

m.p. melting point

### Example 87

### Preparation of 5-methyl-6-(2-chloro-4-(amino-N-hydroximino)phenyl)-7-(4-methylpiperidin-1-yl)-[1,2,4]-triazolo[1,5-a]pyrimidine

### 87.1 5-Methoxycarbonylmethyl-6-(2-chloro-4-cyanoph enyl)-7-(4-methylpiperidin-1-yl)-[1,2,4]-triazolo[1,5-a]pyrimidine

9 g (18.5 mmol) of 5-(bismethoxycarbonylmethyl)-6-(2-chloro-4-cyanophenyl)-7-(4-methylpiperidin-1-yl)-[1,2,4]-triazolo[1,5-a]pyrimidine (prepared analogously to U.S. Pat. No. 5,994,360, EP 550113, WO 94/20501, EP 770615, WO 98/41496) and 5 g of lithium chloride (120 mmol) in 100 ml of dimethyl sulfoxide and 5 ml of water were heated at 110° C. for 8 hours. The mixture was then cooled to room temperature and diluted with water, and the precipitated solid was filtered off with suction. The solid was then taken up in ethyl acetate and the organic phase was dried over magnesium sulfate and concentrated. Trituration with diisopropyl ether gave 4.9 g (62% of theory) of the title compound as a beige solid.

¹H-NMR (CDC₃, δ in ppm): 8.4 (s, 1H); 7.9 (s, 1H); 7.7 (d, 1H); 7.55 (d, 1H); 3.8 (d, 1H); 3.65 (m, 2H); 3.6 (s, 3H); 3.55 (d, 1H); 2.7 (m, 2H); 1.45-1.7 (m, 3H); 1.25 (m, 2H); 0.95 (d, 3H)

### 87.2 5-Methoxycarbonylmethyl-6-(2-chloro-4-(amino-N-hydroximino)phenyl)-7-(4-methylpiperidin-1-yl)-[1,2,4]-triazolo[1,5-a]pyrimidine

0.5 g (1.2 mmol) of 5-methoxycarbonylmethyl-6-(2-chlorocyanophenyl)-7-(4-methylpiperidin-1-yl)-[1,2,4]-triazolo[1,5-a]pyrimidine, 0.5 g (3.6 mmol) of potassium carbonate and 0.5 g (7 mmol) of hydroxylamine hydrochloride in 10 ml of methanol were stirred at 70° C. for 4 hours. The reaction mixture was then concentrated, the residue was taken up in methylene chloride and the organic phase was extracted with dilute hydrochloric acid and water. The organic phase was dried over magnesium sulfate and concentrated and the residue was purified by preparative MPLC on silica gel RP 18 using acetonitrile/water mixtures. This gave 0.3 g (55% of theory) of the title compound as a colorless solid.

¹H-NMR (CDCl₃, δ in ppm): 8.7 (s, broad, 1H); 8.4 (s, 1H); 7.9 (s, 1H); 7.7 (d, 1H); 7.35 (d, 1H); 5.1 (s, 2H); 3.8 (d, 1H); 3.65 (m, 2H); 3.6 (d, 1H); 3.55 (s, 3H); 2.7 (m, 2H); 1.6 (m, 2H); 1.45 (m,₁ H); 1.3 (m, 2H); 0.95 (d, 3H)

### 87.3 5-Methyl-6(2-chloro-4-(amino-N-hydroximino) phenyl)-7-(4-methylpiperidin-1-yl)-[1,2,4]-triazolo[1,5-a]pyrimidine

0.3 g (0.66 mmol) of 5-methoxycarbonylmethyl-6-(2-chloro+(amino-N-hydroximino)phenyl)-7-(4-methylpiperidin-1-yl)-[1,2,4]-triazolo[1,5-a]pyrimidine and 0.3 g (2.2 mmol) of potassium carbonate in 10 ml of methanol and 2 ml of water were stirred at room temperature overnight. The reaction mixture was then concentrated, the residue was taken up in 10 ml of water and 5 ml of acetic acid and this mixture was stirred at 60° C. for 8 hours. The reaction mixture was then concentrated and the residue was purified by preparative MPLC on silica gel RP 18 using acetonitrile/water mixtures. This gave 90 mg (34% of theory) of the title compound as a clear solid having a melting point of 127 to 131 ° C.

¹H HMR (CDCl₃, δ in ppm): 8.7 (s, very broad, 1H); 8.4 (s, 1H); 7.95 (s, 1H); 7.8 (d, 1H); 7.3 (d, 1H); 5.4 (s, 2H); 3.75 (m, 1H); 3.55 (m, 1H); 2.7 (m, 2H); 2.3 (s, 3H), 1.6 (m, 2H); 1.45 (m, 1H); 1.3 (m, 2H); 0.9 (d, 3H)

Examples of the action against harmful fungi

The fungicidal action of the compounds of the formula I was demonstrated by the following experiments:

### Use example 1

### Activity Against Early Blight of Tomato Caused by Alternaria solani, Protective Application

Leaves of potted plants of the cultivar “Pixie II” which had been cultivated in pots up to the 4-leaf stage were sprayed to run off point with an aqueous preparation of active compound which had been prepared from a stock solution of 5% active compound, 94% acetone and 1% emulsifier (Tween 20). After the spray coating had dried on (3 to 5 hours) the leaves were inoculated with an aqueous spore suspension of Afternaria solani (density 15×10³ spores/ml). The plants were then placed in an acclimatized chamber at 22-24° C. and 96-98% relative atmospheric humidity for 36 hours and then cultivated in a greenhouse at 21-23° C. and approximately 95% relative atmospheric humidity for a further 2 to 3 days. The extent of the development of the infection on the leaves was then determined visually.

In this test, the plants which had been treated with 250 ppm of the title compound from example 2, example 3, example 4, example 5, example 6, example 9, example 10, example 11, example 13, example 14, example 16, example 18, example 19 or example 20 showed an infection of not more than 15%, whereas the untreated plants were 90% infected.

1. The use of substituted triazolopyrimidines of the formula I 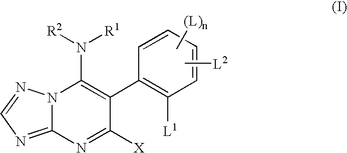
in which:
R¹, R₂ independently of one another are hydrogen, C₁-C₈-alkyl, C₁-C₈-haloalkyl, C₃-C₁₀-cycloalkyl, C₃-C₈-halocycloalkyl, C₂-C₈-alkenyl, C₄-C₁₀-alkadienyl, C₂-C₈-haloalkenyl, C₃-C₈-cycloalkenyl, C₃-C₈-halocycloalkenyl, C₂-C₈-alkynyl, C₂-C₈-haloalkynyl, phenyl, naphthyl, or a five- to ten-membered saturated, partially unsaturated or aromatic heterocycle which contains one, two, three or four heteroatoms from the group consisting of O, N or S, or
R¹ and R² together with the nitrogen atom to which they are attached form a five- to eight-membered heterocyclyl or heteroaryl which is attached via nitrogen and may contain one, two or three further heteroatoms from the group consisting of O, N and S as ring members and/or may carry one or more substituents from the group consisting of halogen, C₁-C₆-alkyl, C₁-C₆-haloalkyl, C₂-C₆-alkenyl, C₂-C₆-haloalkenyl, C₁-C₆-alkoxy, C₁-C₆-haloalkoxy, C₃-C₆-alkenyloxy, C₃-C₆-haloalkenyloxy, (exo)-C₁-C₆-alkylene and oxy-C₁-C₃-alkyleneoxy; where R¹ and R² may carry one, two, three or four identical or different groups R^{a}:
R^{a} is halogen, cyano, nitro, hydroxyl, C₁-C₆-alkyl, C₁-C₆-haloalkyl, C₁-C₆-alkylcarbonyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₂-C₈-alkenyl, C₂-C₈-haloalkenyl, C₃-C₈-Cycloalkenyl, C₂-C₆-alkenyloxy, C₃-C₆-haloalkenyloxy, C₂-C₆-alkynyl, C₂-C₆-haloalkynyl, C₃-C₆-alkynyloxy, C₃-C₆-haloalkynyloxy, C₃-C₆-cycloalkoxy, C₃-C₈-cycloalkenyloxy, oxy-C₁-C₃-alkyleneoxy, phenyl, naphthyl, a five- to ten-membered saturated, partially unsaturated or aromatic heterocycle which contains one, two, three or four heteroatoms from the group consisting of O, N and S, where these aliphatic, alicyclic or aromatic groups for their part may be partially or fully halogenated or may carry one, two or three groups R^{b}:
R^{b} is halogen, cyano, nitro, hydroxyl, mercapto, amino, carboxyl, aminocarbonyl, aminothiocarbonyl, alkyl, haloalkyl, alkenyl, alkenyloxy, alkynyloxy, alkoxy, haloalkoxy, alkylthio, alkylamino, dialkylamino, formyl, alkylcarbonyl, alkylsulfonyl, alkylsulfoxyl, alkoxycarbonyl, alkylcarbonyloxy, alkylaminocarbonyl, dialkylaminocarbonyl, alkylaminothiocarbonyl, dialkylaminothiocarbonyl, where the alkyl groups in these radicals contain 1 to 6 carbon atoms and the alkenyl or alkynyl groups mentioned in these radicals contain 2 to 8 carbon atoms; and/or one to three of the following radicals:
cycloalkyl, cycloalkoxy, heterocyclyl, heterocyclyloxy, where the cyclic systems contain 3 to 10 ring members; aryl, aryloxy, arylthio, aryl-C₁-C₆-alkoxy, aryl-C₁-C₆-alkyl, hetaryl, hetaryloxy, hetarylthio, where the aryl radicals preferably contain 6 to 10 ring members and the hetaryl radicals 5 or 6 ring members, where the cyclic systems may be partially or fully halogenated or may be substituted by alkyl or haloalkyl groups;
L independently of one another are halogen, C₁-C₆-alkyl, C₁-C₆-haloalkyl, C₁-C₆-alkoxy, C₁-C₆-haloalkoxy, C₂-C₆-alkenyloxy, cyano, C(═O)A¹, S(═O)ₘA², NR^{c}R^{d} or NR^{c}—(C═O)—R^{d}, in which
A¹ is hydrogen, hydroxyl, C₁-C₈-alkyl, C₁-C₈-alkoxy, C₁-C₈-haloalkoxy, amino, C₁-C₈-alkylamino, di-(C₁-C₈-alkyl)amino, C₂-C₈-alkenyl;
A² is hydrogen, hydroxyl, C₁-C₈-alkyl, amino, C₁-C₈-alkylamino, di-(C₁-C₈-alkyl)amino;
R^{c}, R^{d} independently of one another are hydrogen, C₁-C₆-alkyl, C₂-C₁₀-alkenyl, C₂-C₁₀-alkynyl, C₃-C₆-cycloalkyl, C₃-C₈-cycloalkenyl, where the 5 last-mentioned radicals may be partially or fully halogenated or may carry one, two, three or four radicals selected from the group consisting of cyano, C₁-C₄-alkoximino, C₂-C₄-alkenyloximino, C₂-C₄-alkynyloximino and C₁-C₄-alkoxy; and
m is 0, 1 or 2;
L¹ is halogen, C₁-C₆-alkyl or C₁-C₆-haloalkyl;
L² is nitro, a group —C(S)NR³R⁴, a group —C(═N—OR⁵)(NR⁶R⁷) or a group —C(═N—NR⁸R⁹)(NR¹⁰R¹¹),
X is halogen, cyano, C₁-C₄-alkyl, C₁-C₄-alkoxy, C₁-C₄-haloalkyl or C₁-C₂-haloalkoxy;
R³, R⁴, R⁵, R₆, R⁷, R₈, R⁹, R¹⁰ and R¹¹ are independently of one another selected from the group consisting of hydrogen, C₁-C₆-alkyl, C₃-C₆-cycloalkyl, C₂-C₆-alkenyl and C₂-C₆-alkynyl, where the 4 last-mentioned radicals may carry one, two, three, four, five or six radicals R^{a}; or
R³ and R⁴, R⁶ and R⁷, R₈ and R₉ and/or R¹⁰ and R¹¹ together with the nitrogen atom to which they are attached form a four-, five- or six-membered saturated or partially unsaturated ring which may carry one, two, three, or four substituents independently of one another selected from R^{a}; and
n is 0, 1, 2 or 3
and the agriculturally acceptable salts thereof for controlling phytopathogenic fungi.

2. The use according to claim 1 in which R¹ in formula I is different from hydrogen and R² is hydrogen.

3. The use according to claim 1 in which X in formula I is halogen, C₁-C₄-alkyl, cyano, C₁-C₄-alkoxy or C₁-C₄-haloalkyl.

4. The use according to claim 3 in which X in formula I is chlorine.

5. The use according to claim 1 in which L in formula I is selected from the group consisting of halogen, cyano, C₁-C₆-alkyl, C₁-C₄-haloalkyl, C₁-C₆-alkoxy and C₁-C₆-alkoxycarbonyl.

6. The use according to claim 5 in which L in formula I is halogen.

7. The use according to claim 1 in which n in formula I is 0 or 1.

8. The use according to claim 1 in which L¹ in formula I is halogen or C₁-C₂-alkyl.

9. The use according to claim 8 in which L¹ in formula I is fluorine, chlorine or methyl.

10. The use according to claim 1 in which L² in formula I is nitro or a group —C(S)NR³R⁴.

11. The use according to claim 10 in which R³ and R⁴ in formula I are each hydrogen.

12. The use according to claim 1 in which L² in formula I is attached in the 4-position or 5-position relative to the point of attachment to the triazolopyrimidine skeleton.

13. The use according to claim 1 in which in formula I X is chlorine, L¹ is fluorine, chlorine or methyl and L² is nitro.

14. A triazolopyrimidine of the formula I in which R¹, R², X, L¹, L² and (L)ₙ are as defined in claim 1 or an agriculturally acceptable salt thereof, except for compounds of the formula I in which n=0 if at the same time L¹ is fluorine or chlorine and L² is a nitro group located in the 4-position.

15. A composition for controlling phytopathogenic fungi, which composition comprises at least one compound of the formula I according to claim 1 and/or an agriculturally acceptable salt of I and at least one solid or liquid carrier.

16. A method for controlling phytopathogenic fungi, which method comprises treating the fungi or the materials, plants, the soil or seed to be protected against fungal attack with an effective amount of a compound of the formula I according to claim 1 and/or an agriculturally acceptable salt of I.

17. The use according to claim 2 in which X in formula I is halogen, C₁-C₄-alkyl, cyano, C₁-C₄-alkoxy or C₁-C₄-haloalkyl.

18. The use according to claim 2 in which L in formula I is selected from the group consisting of halogen, cyano, C₁-C₆-alkyl, C₁-C₄-haloalkyl, C₁-C₆-alkoxy and C₁-C₆-alkoxycarbonyl.

19. The use according to claim 3 in which L in formula I is selected from the group consisting of halogen, cyano, C₁-C₆-alkyl, C₁-C₄-haloalkyl, C₁-C₆-alkoxy and C₁-C₆-alkoxycarbonyl.

20. The use according to claim 4 in which L in formula I is selected from the group consisting of halogen, cyano, C₁-C₆-alkyl, C₁-C₄-haloalkyl, C₁-C₆-alkoxy and C₁-C₆-alkoxycarbonyl.
